(19) United States
(12) Patent Application Publication
(10) Pub. No.: US 2009/0155448 A1
(43) Pub. Date: Jun. 18, 2009

(54) Organic Protein Extrudates and Preparation Thereof

(75) Inventors: Santiago Solorio, Bridgeton, MO (US); Phillip I. Yakubu, St. Louis, MO (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 11/955,155

(22) Filed: Dec. 12, 2007

(51) Int. Cl. A23J 3/16; A23J 3/14

(52) U.S. Cl. 426/656

(57) ABSTRACT

The present disclosure relates to organic protein extrudates using organic soy proteins as starting materials and food products containing these organic protein extrudates. As a result of using organic starting materials, the organic protein extrudates have a higher concentration of fat and dietary fiber. Moreover, the present disclosure relates to extrusion processes for producing the organic protein extrudates using organic soy proteins as starting materials.

### FIELD OF THE INVENTION

The present disclosure relates to organic protein extrudates containing organic soy protein, high concentrations of fat, and high concentrations of dietary fiber, processes for manufacturing such organic protein extrudates, and the use of such organic protein extrudates as functional food ingredients.

### BACKGROUND OF THE INVENTION

In today's food industry, pesticides, herbicides and other residual processing chemicals are increasingly becoming common in the food chain. The long term effects of these chemicals, however, are not completely understood. Accordingly, many health conscious consumers are becoming interested in natural and organic food and drink products that minimize their potential residual chemical intake. Furthermore, these natural and whole grain foods have been reported to further improve health and prolong life. As such, organic and whole grain snacks and food products may be a good source of protein for health conscious consumers.

Organic, natural, and/or whole grain ingredients in food products have different physicochemical properties as compared with traditional ingredients. Despite the different properties, consumers expect organic, natural and whole grain-containing food products to have similar nutritional, physicochemical, and organoleptic properties as compared to traditional foods. The challenge facing the food industry, therefore, is to provide acceptable organic and/or whole grain-containing food products to consumers without changing the nutritional, physiocochemical, and organoleptic properties thereof.

Texturized protein products are known in the art and are typically prepared by heating a mixture of protein material along with water under mechanical pressure in a cooker extruder and extruding the mixture through a die. Upon extrusion, the extrudate generally expands to form a fibrous cellular structure as it enters a medium of reduced pressure (usually atmospheric). Expansion of the extrudate typically results from inclusion of soluble carbohydrates which reduce the gel strength of the mixture.

### SUMMARY OF THE INVENTION

Among the various aspects of the invention are protein extrudates containing high concentrations of vegetable protein, dairy protein, mixtures thereof

Another aspect of the invention is a protein extrudate comprising at least 15 wt. % vegetable protein on a moisture-free basis and from 5.5 wt. % to 13 wt. % fat on a moisture-free basis, the extrudate having a density from 0.0.02 to 0.5 g/cm³.

Yet a further aspect of the invention is using the protein extrudates described above in food products, particularly snack foods and/or breakfast foods.

Other objects and features will be in part apparent and in part pointed out hereinafter.

### BRIEF DESCRIPTION OF THE DRAWINGS

FIG. 1 is a schematic flow diagram of a process useful in preparing the protein extrudates of the present disclosure.

### DETAILED DESCRIPTION OF THE PREFERRED EMBODIMENTS

In accordance with the present disclosure, it has been discovered that textured protein products containing proteins such as organic proteins and high concentrations of fat and dietary fiber can be manufactured to have a desired taste and an acceptable texture using extrusion technology. As used herein, the term “organic” generally refers to products that undergo substantially no chemical alteration or processing during manufacture. Specifically, as used herein, “organic” products are defined as the term is defined by the U.S. Department of Agriculture standards; that is, those products that are manufactured without using conventional pesticides, fertilizers made with synthetic ingredients, or sewage sludge, bioengineering, or ionizing radiation. “Organic protein extrudates” are protein extrudates whose protein content is made up solely of organic protein sources such as organic soy protein sources or other organic vegetable sources. Such protein extrudates can be formed as “nuggets” or pellets for use as an ingredient or source of protein in health and nutrition bars, snack bars and ready to eat cereal, etc. Alternatively, the protein extrudates may be further processed for use as a binder, a stabilizer or a source of protein in beverages, health and nutrition bars, dairy, and baked goods and emulsified/ground meat food systems. In certain embodiments, the protein extrudates may be ground into fine particles (i.e., powder) to allow for incorporation into soy beverages.

A process for preparing protein extrudates including organic protein extrudates generally comprises forming a conditioned feed mix containing protein by contacting a feed mixture containing protein with moisture, introducing the conditioned feed mix into an extruder barrel, heating the conditioned feed mix under mechanical pressure to form a molten extrusion mass, and extruding the molten extrusion mass through a die to produce the protein extrudate.

Feed mixtures having a fat content as described herein present difficulties in preparing protein extrudates having acceptable density, texture, and sensory attributes. Further, the high fat feed mixtures can cause problems with moving the feed mixtures through the extrusion process as well as a higher potential to plug filters in the process. Additionally, high fat feed mixtures will oxidize faster at conventional extrusion temperatures than lower fat feed mixtures and the fat can separate from the feed mixture at conventional extrusion temperatures. Further, when the feed mixture separates, a high fat waste stream is produced and this waste stream must also be processed.

### Protein

The protein-containing feed mixture comprises at least one source of protein and has an overall protein concentration of at least about 10%, 15%, 20%, 30%, 40%, 50%, 60%, 70%, 80%, 90%, or more protein by weight on a moisture-free basis. In various preferred embodiments, the protein concentration in the feed mixture is at least about 50%, 60%, 70%, 80%, 90%, or more protein by weight on a moisture-free basis. Proteins contained in the feed mixture may be obtained from one or more suitable sources including, for example, vegetable protein materials. Vegetable protein materials may be obtained from cereal grains such as wheat, corn, and barley, and vegetables such as legumes, including soybeans and peas. In preferred embodiments, a soy protein material is the source of the protein. In other preferred embodiments, the protein is an organic vegetable material having overall protein concentration of at least about 10%, 15%, 20%, 30%, 40%, 50%, 60%, 70%, 80%, 90%, or more protein by weight on a moisture-free basis, such as an organic soy protein.

Typically, when soy protein is present in the protein extrudates, the soy protein is present in an amount of from about 50% to about 99% by weight on a moisture-free basis based on the weight of the protein extrudate. In some instances, the soy protein is present in the protein extrudate in an amount of from about 50% to about 90% by weight on a moisture-free basis and, in other instances, from about 55% to about 85% by weight on a moisture-free basis, or from about 55% to about 75% by weight on a moisture-free basis.

Suitable soy protein materials include soy flakes, soy flour, soy grits, soy meal, soy protein concentrates, soy protein isolates, and mixtures thereof. The primary difference between these soy protein materials is the degree of refinement relative to whole soybeans. Soy flour generally has a particle size of less than about 150 μm. Soy grits generally have a particle size of about 150 μm to about 1000 μm. Soy meal generally has a particle size of greater than about 1000 μm. Soy protein concentrates typically contain about 65 wt. % to less than 90 wt. % soy protein. Soy protein isolates, more highly refined soy protein materials, are processed to contain at least 90 wt. % soy protein and little or no soluble carbohydrates or fiber.

The overall protein content of the feed mixture may be achieved by a combination (i.e., blend) of suitable sources of protein described above. In certain embodiments, when soy protein is used, it is preferred for soy protein isolates to constitute one or more of the sources of protein contained in the feed mixture. For example, a preferred feed mixture formulation may comprise a blend of two or more soy protein isolates. Other suitable formulations may comprise a soy protein concentrate in combination with a soy protein isolate.

Generally, the bulk density of the source of soy protein, other protein source, or blend of sources is from about 0.20 g/cm³ to about 0.50 g/cm³ and, more typically, from about 0.24 g/cm³ to about 0.44 g/cm³.

Blends of Hydrolyzed and Unhydrolyzed Proteins

In certain embodiments in which the feed mixture comprises a plurality of soy protein materials, it is desired that at least one of the soy protein materials exhibits low viscosity and low gelling properties. The viscosity and/or gelling properties of an isolated soy protein may be modified by a wide variety of methods known in the art. For example, the viscosity and/or gelling properties of a soy protein isolate may be decreased by partial hydrolysis of the protein with an enzyme which partially denatures the protein materials. Typically, soy protein materials treated in this manner are described in terms of degree of hydrolysis which can be determined based on molecular weight distributions, sizes of proteins and chain lengths, or breaking down of beta-conglycinin or glycinin storage proteins. As used herein, the term “percent degree of hydrolysis” of a sample is defined as the percentage of cleaved peptide bonds out of the total number of peptide bonds in the sample. The proportion of cleaved peptide bonds in a sample can be measured by calculating the amount of trinitrobenzene sulfonic acid (TNBS) that reacts with primary amines in the sample under controlled conditions.

Hydrolyzed protein materials used in accordance with the process of the present invention typically exhibit TNBS values of less than about 160, more typically less than about 115 and, still more typically, from about 30 to about 70.

Hydrolyzed soy protein sources sufficient for use as a low viscosity/low gelling material in the process of the present invention typically have a degree of hydrolysis of less than about 15%, preferably less than about 10% and, more preferably, from about 1% to about 5%. In the case of soy protein isolates, the hydrolyzed soy protein material typically comprises a partially hydrolyzed soy protein isolate having a degree of hydrolysis of from about 1% to about 5%.

In accordance with some embodiments of the present invention, a low viscosity/low gelling source is preferably combined with a high viscosity/high gelling source to form the blend. The presence of the high viscosity/high gelling source reduces the risk of excessive expansion of the blend upon extrusion, provides a honeycomb structure to the extrudate, and generally contributes stability to the blend. The low viscosity/low gelling and high viscosity/high gelling sources can be combined in varying proportions depending on the desired characteristics of the extrudate.

In a preferred embodiment, the protein-containing feed mixture typically comprises a blend of soy protein isolates comprising at least about 3 parts by weight of a hydrolyzed (i.e., generally low viscosity/low gelling) soy protein isolate per part by weight of an unhydrolyzed (i.e., generally high viscosity/high gelling) soy protein isolate, in other embodiments, at least about 4 parts by weight of a hydrolyzed soy protein isolate per part by weight of an unhydrolyzed soy protein isolate and, in still other embodiments, at least about 5 parts by weight of a hydrolyzed soy protein isolate per part by weight of an unhydrolyzed soy protein isolate. Preferably, the blend of soy protein isolates comprises from about 3 parts by weight to about 8 parts by weight of a hydrolyzed soy protein isolate per part by weight of an unhydrolyzed soy protein isolate. More preferably, the blend of soy protein isolates comprises from about 5 parts by weight to about 8 parts by weight of a hydrolyzed soy protein isolate per part by weight of an unhydrolyzed soy protein isolate.

In various preferred embodiments, the protein extrudate also comprises the same ratios of hydrolyzed:unhydrolyzed soy protein as described for the feed mixture.

Blends comprising a plurality of soy protein isolates, one of which is a low viscosity/low gelling source produced by partial hydrolysis of a soy protein isolate typically comprise from about 40% to about 80% by weight of a hydrolyzed soy protein isolate on a moisture-free basis and from about 0% to about 20% by weight of an unhydrolyzed soy protein isolate on a moisture-free basis. More typically, such blends comprise from about 50% to about 75% by weight of a hydrolyzed soy protein isolate on a moisture-free basis and from about 5% to about 15% by weight of an unhydrolyzed soy protein isolate on a moisture-free basis.

Blends comprising a plurality of soy protein isolates typically comprise from about 40% to about 80% by weight of a hydrolyzed soy protein isolate on a moisture-free basis and from about 1% to about 20% by weight of an unhydrolyzed soy protein isolate on a moisture-free basis, based on the weight of the feed mixture or protein extrudate. More typically, such blends comprise from about 50% to about 75% by weight of a hydrolyzed soy protein isolate on a moisture-free basis and from about 5% to about 15% by weight of an unhydrolyzed soy protein isolate on a moisture-free basis.

Suitable isolated soy protein sources for use as a low viscosity/low gelling (i.e., partially hydrolyzed) soy protein material include SUPRO® 219, SUPRO® 312, SUPRO® 313, SUPRO® 670, SUPRO® 710, SUPRO® 8000, and Soless® H102 available from Solae, LLC (St. Louis, Mo.), and PROFAM 931 and PROFAM 873 available from Archer Daniels Midland (Decatur, Ill.). For SUPRO® 670, SUPRO® 710, and SUPRO® 8000, the degree of hydrolysis can range from about 0.5%-5.0%. The molecular weight distribution of each of these isolates can be determined by size exclusion chromatography.

Suitable sources of soy protein that are certified organic are SOYQUICK ISP 90 and SOYQUICK ISO 90 from American Health and Nutrition. Suitable sources of high viscosity and/or medium/high gelling isolated soy protein (i.e., unhydrolyzed) for use as the second soy protein isolate include SUPRO® 248, SUPRO® 620, SUPRO® 500E, SUPRO® 630, SUPRO® 1500, SUPRO® EX33, SUPRO® EX45, ISP-95, Soy Quick® ISP 90, Soless® G101, Fuji Pro® Deluxe White-ISP available from Solae, LLC (St. Louis, Mo.); PROFAM 981 available from Archer Daniels Midland (Decatur, Ill.); and Solae soy protein isolate available from Solae, LLC (St. Louis, Mo.).

Table 1 provides molecular weight distributions for certain of the commercial SUPRO® products mentioned above.

TABLE 1
Average Molecular Weight of Solae soy protein products determined
using HPLC-SEC (High Performance Liquid Chromatography - Size
Exclusion Chromatography) gel filtration in 6 M guanidine HCl.

| Hydrolyzed | Average Mol. Wt. | Unhydrolyzed | Average Mol. Wt. |
|---|---|---|---|
| Soy Protein | (SEC [Daltons]) | Soy Protein | (SEC [Daltons]) |
| SUPRO ® 313 | 8000-12000 | SUPRO ® 620 | 30000-35000 |
| SUPRO ® 710 | 12000-14000 | SUPRO ® 248 | 30000-35000 |
| SUPRO ® 219 | 12000-14000 | SUPRO ® 1500 | 30000-35000 |
| SUPRO ® 750 | 12000-14000 | ISP-95 | 30000-35000 |
| SUPRO ® 312 | 14000-18000 | SUPRO ® EX 45 | 30000-35000 |
| SUPRO ® | 14000-18000 | Soy Quick ISP 90 | 30000-35000 |
| 8000 | | | |
| SOLESS H102 | 14000-18000 | SOLESS G101 | 30000-38000 |
| SUPRO ® 670 | 19000-25000 | SOLAE NAP-ISP | 30000-38000 |

### Preparation of Organic Soy Protein Isolates

In preparing non-organic soy protein isolates, the process includes (1) dehulling whole soybeans; (2) flaking the dehulled soybeans; (3) extracting soybean oil from the flaked soybeans with a solvent such as hexane; (4) desolventizing the defatted soybean flakes without high heating or toasting to produce white flakes having a high polydispersity index (PDI); (5) slurrying the white flakes with water to extract protein; (6) removing solids to obtain an aqueous protein extract; (7) adding an acid to the protein extract to lower the pH of the protein extract to the isoelectric point to form a slurry of solid curds and liquid whey; (8) removing the curds from the slurry; (9) washing the curds; and (10) drying the curds to a powder.

Steps 1 through 4 described above are commonly referred to as the extraction process for soybeans. The general procedure for the above-described steps 1 through 4 is well understood, as described in U.S. Pat. No. 5,097,017 to Konwinski, assigned to the assignee of the present invention, the disclosure of which is expressly incorporated herein by reference.

The first step in the conventional process is dehulling. Dehulling is the process in which the soybean hulls are removed from the whole soybeans. The soybeans are carefully cleaned prior to dehulling to remove foreign matter, so that product will not be contaminated by color bodies. Soybeans also are normally cracked into about 6 to 8 pieces prior to dehulling. The hull typically accounts for about 8.0 wt. % of the weight of the whole soybean. The dehulled soybean is about 10.0 wt. % water, 40.0 wt. % protein, 20.0 wt. % fat, with the remainder mainly being carbohydrates, fiber and minerals.

The dehulled soybeans are conditioned prior to flaking by adjusting moisture and temperature to make the soybean pieces sufficiently plastic. The conditioned soybean pieces are passed through flaking rolls to form flakes about 0.01 to 0.012 inches (in.) thick. The soybean flakes are defatted by contacting them with a solvent, such as hexane, to remove the soybean oil. The soybean oil is used in many applications, such as margarine, shortening and other food products, and is a good source of lecithin, which has many useful applications as an emulsifier.

The hexane-defatted soybean flakes are desolventized to remove the solvent, without toasting, to produce white flakes. The white flakes may be ground to make soy flour. Commercial soy flour typically has at least 50.0 wt. % (52.5 wt. %) protein (N X 6.25); about 30.0 to 40.0 wt. % (34.6 wt. %) carbohydrates; about 5.0 to 10.0 wt. % (6.0 wt. %) moisture; about 5.0 to 10.0 wt. % (6.0 wt. %) ash; about 2.0 to 3.0 wt. % (2.5 wt. %) crude fiber and less than about 1.0 wt. % (0.9 wt. %) fat (as determined by ether extraction).

The defatted, desolventized soybean flakes are then placed in an aqueous bath to provide a mixture having a pH of at least about 6.5 and preferably between about 7.0 and 10 in order to extract the protein. If it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7 is generally preferred, since an alkaline extraction facilitates solubilization of the protein. Typically, the pH of the aqueous extract of protein, will be at least about 6.5 and preferably about 7.0 to 10. The ratio by weight of the aqueous extractant to the vegetable protein material is usually between about 20 to 1 and preferably a ratio of about 10 to 1. In an alternative embodiment, the vegetable protein is extracted from the milled, defatted flakes with water without a pH adjustment.

Solids are removed in the sixth step to give a clear protein extract. The solids are removed by known methods of decantation, filtration, centrifugation, and the like.

An acid is added to the separated extract to lower the pH of the extract to around the isoelectric point of the soy protein, preferably to a pH of from 4.0 to 5.0, and most preferably to a pH of from 4.4 to 4.6. Addition of an acid causes the formation of solid curds. The liquid phase is whey. The soy protein precipitates from the acidified extract due to the lack of solubility of the protein in an aqueous solution at or near its isoelectric point. The precipitation step may be conveniently carried out by the addition of a common food grade acidic reagent such as acetic acid, sulfuric acid, phosphoric acid, hydrochloric acid or with any other suitable acidic reagent.

The solid curd is separated from the whey, which is usually discarded. A convenient separation method is centrifugation. The contents of the whey are the soluble carbohydrates of sucrose, stachyose, raffinose, lactose, and low molecular weight proteins.

Residual amounts of soluble carbohydrates and/or low molecular weight proteins are then removed by water washing in step nine, followed by an additional separation step. Typically, the pH of the curd is increase up to between about 6.5 and 7.5. The separated protein is then dried using conventional drying means such as spray drying or tunnel drying to form a soy protein isolate.

For the preparation of organic soy protein isolates, various steps in the conventional process described above are altered. Generally, this process for preparing organic soy protein isolates is referred to herein as the non-acid precipitation (NAP) process. First, solvent extraction is not used to remove oil. The oil is removed from the soy flakes by mechanical pressing. Although pressing does not remove all of the soybean oil, it is desirable because it increases process safety by removing contact of the soy flakes with hexane,and lowers initial capital costs. Disadvantages of mechanical pressing are: (1) low capacity of obtained oil; (2) high residual oil in the press cake; (3) high power requirements; and (4) high maintenance and operator skill.

Additionally, when precipitation is accomplished by adding an inorganic acid to the protein extract to lower the pH to the isoelectric point, the isolate produced cannot be certified organic.

Further, the source of the starting soy protein are either full fat soy protein flakes/flour or flakes/flour obtained after mechanical pressing. The full fat flakes/flour have a fat content as measured by acid hydrolysis of about 18 wt. % to about 22 wt. % as is basis. Flakes/flour obtained after mechanical pressing have a fat content as measured by acid hydrolysis of about 6 wt. % to about 17 wt. % as is basis.

In the present invention, protein precipitation is conducted by the use of a saturated aqueous solution of a metal salt wherein the metal is an alkali metal or an alkaline earth metal. Preferred alkali metals are sodium and potassium and preferred alkaline earth metals are magnesium and calcium. In various preferred embodiments, calcium is the metal. These metal salts can be neutral salts and acid salts. Neutral salts are sodium chloride, sodium sulfate, sodium phosphate, potassium chloride, potassium sulfate, potassium phosphate, and mixtures thereof. Various preferred acidic salts are magnesium chloride, magnesium sulfate, magnesium phosphate, calcium chloride, calcium sulfate, calcium phosphate, and mixtures thereof, preferably, the acidic salt is calcium chloride.

### Expansion Aids

Modified starch such as rice flour, pregelatinized starch such as tapioca or rice flour, Fibrim (FIBRIM® brand soy fiber is an 80 percent total dietary fiber ingredient available from Solae, LLC, dicalcium phosphate, and soy lecithin powder can be added to control expansion of the protein extrudate, modify the cell structure in final products, and help improve the flowability of the feed mixture in the process. In various embodiments, the expansion aids are certified organic.

### Carbohydrates

The protein-containing feed mixture may also contain one or more carbohydrate sources in an amount of from about 0.001% to about 45% by weight carbohydrates on a moisture-free basis. The carbohydrates present in the feed mixture can be soluble carbohydrates or insoluble carbohydrates. Typically, the protein-containing feed mixture comprises about 10% to about 40% by weight carbohydrates on a moisture-free basis and, more typically from about 16% to about 40% by weight carbohydrates on a moisture-free basis. Preferably, the extrudate contains 10% to 20% by weight carbohydrates. In other instances, from about 1 to about 5 wt. % or from about 1 to about 10 wt. % carbohydrates are in the feed mixture or protein extrudate. Suitable sources of soluble carbohydrates include, for example, cereals, tubers and roots such as rice (e.g., rice flour), wheat, corn, barley, potatoes (e.g., native potato starch), and tapioca (e.g., native tapioca starch). Insoluble carbohydrates such as fiber do not contribute to nutritive carbohydrate load yet aid in processing of the mixture by facilitating flowability and expansion of the feed mixture. Generally, the feed mixture comprises from about 0.001% to about 5% by weight fiber and, more generally, from about 1% to about 3% by weight fiber. Soy fiber absorbs moisture as the extrusion mass flows through the extrusion barrel to the die. A modest concentration of soy fiber is believed to be effective in reducing cross-linking of protein molecules, thus preventing excessive gel strength from developing in the cooked extrusion mass exiting the die. Unlike the protein, which also absorbs moisture, soy fiber readily releases moisture upon release of pressure at the die exit temperature. Flashing of the moisture released contributes to expansion, i.e., “puffing,” of the extrudate, and producing the low density extrudate of the invention. Typically, the extrudates also contain from about 0.001% to about 10% by weight fiber on a moisture free basis and, more typically, from about 3% to about 8% by weight fiber on a moisture free basis.

### Water

Generally, water is present in the dried extrudate at a concentration of from about 2% to about 5.5% by weight. The amount of water may vary depending on the composition and physical properties of the extrudate (e.g., carbohydrate content and density).

### Physical Properties

Generally, the protein extrudates of the present invention have a density of from about 0.02 g/cm³ to about 0.5 g/cm³. Preferably, the protein extrudates of the present invention have a density of from about 0.1 to about 0.4 g/cm³ or from about 0.15 g/cm³ to about 0.35 g/cm³. In such embodiments, the density of the extrudate may be from about 0.20 g/cm³ to about 0.27 g/cm³, from about 0.24 g/cm³ to about 0.27 g/cm³, or from about 0.27 g/cm³ to about 0.32 g/cm³. In other instances, the protein extrudate is a puff having a density of from about 0.02 to about 0.1 g/cm³ or from about 0.02 to about 0.05 g/cm³.

In various embodiments, soy protein isolate and native tapioca starch are used to help create expansion in the extrudates and obtain the desired product density. These ingredients release the water trapped during the extrusion cooking process and the expansion of the extrudates occurs when the water used as plasticizer is released as steam upon the extrudate's exit from the extruder die. The water is released as steam because the extrudate experiences a change from higher temperature and pressure to atmospheric temperature and pressure and this causes the cells in the final product to expand. Further, the formulation ingredients tend to retract to the original form and this effect is called the shrinkage ratio. Better expansion or reduction of the shrinkage ratio is achieved when hydrolyzed soy protein isolate and native tapioca starch are present in the formula, forming larger cells in the product structure. Because of the larger size of the cells, the concentration of cells in the product decreases and the air space in the product increases, thus affecting the texture and resulting in a lower density product.

The protein extrudates of the present invention may further be characterized as having a hardness of at least about 1000 grams. Typically, the protein extrudates have a hardness of from about 1000 grams to about 50,000 grams and, more typically, from about 5,000 grams to about 40,000 grams. In various preferred embodiments, the hardness is from about 7,000 grams to about 30,000 grams. The hardness of the extrudates is generally determined by placing an extrudate sample in a container and crushing the sample with a probe. The force required to break the sample is recorded; the force that is required to crush the sample based on its size or weight is proportional to the hardness of the product. The hardness of the extrudates may be determined using a TA.TXT2 Texture Analyzer having a 25 kg load cell, manufactured by Stable Micro Systems Ltd. (England).

Further the protein extrudates have a crispiness value of about 5-9. The crispiness is measured by TA.TXT2 Texture Analyzer programmed to measure crispiness. The products can also have a wide range of pellet durability index (PDI) values usually on the order of from about 65-99, more preferably from about 80-97.

### Particle Sizes

The protein extrudates may exhibit a wide range of particle sizes and may generally be characterized as an oval or round nugget or pellet. The following weight percents for characterizing the particle sizes of the extrudates of the present invention are provided on an “as is” (i.e., moisture-containing) basis.

The extrudate nuggets described above can also be ground to produce a powdered soy protein product. Such powder typically has a particle size appropriate to the particular application. In certain embodiments, the powder has an average particle size of less than about 10 μm. More typically, the average particle size of the ground extrudate is less than about 5 μm and, still more typically, from about 1 to about 3 μm.

### Color

The color intensity of the protein extrudate can be adjusted using cocoa powder, caramel, and mixtures thereof. Increasing the amount of cocoa powder and/or caramel yields darker, more intensely colored extrudates. Cocoa is added to the protein-containing feed mixture in the form of cocoa powder. Typically, the protein-containing feed mixture comprises from about 1% to about 8% by weight cocoa powder based on the total weight of the feed mixture on a moisture-free basis. Suitable cocoa powder sources are Cocoa Powder from Bloomer Chocolate (Chicago, Ill.) and ADM Cocoa, Archer Daniels Midland (Decatur, Ill.).

In various embodiments, the color L value of the protein extrudate is greater than 50. In some of these various embodiments, the color A value of the protein extrudate is 2.5 to 4. In other various embodiments, the color B value of the protein extrudate is 17 to 20. Alternatively, in other embodiments, the color L value of the protein extrudate is less than 35.

### Food Products

The extrudates of the present invention are suitable for incorporation into a variety of food products including, for example, food bars and ready to eat cereals. Such extrudates may generally be oval or round and may also be shredded. Powdered extrudates are suitable for incorporation into a variety of food products including, for example, beverages, dairy products (e.g., soy milk and yogurt), baked products, meat products, soups, and gravies. The protein extrudates can be incorporated in such applications in the form of nuggets or pellets, shredded nuggets or pellets, or powders as described above. A particle size of less than about 5 μm is particularly desirable in the case of extrudates incorporated into beverages to prevent a “gritty” taste in the product.

In some embodiments, the protein extrudate is in the form of a low density food product, such as a snack food or breakfast cereal. Typically, such products include between about 25 wt. % and about 95 wt. % protein, and in some instances, at least about 55 wt. %, 60 wt. %, 70 wt. %, 80 wt. %, 90 wt. % or more protein. These low density food products generally have a density of from about 0.02 g/cm³ to about 0.7 g/cm³ and, more generally, from about 0.02 g/cm³ to about 0.5 g/cm³. Generally, such extrudates exhibit a crisp, non-fibrous eating texture. In certain embodiments, the products have a density of from about 0.1 g/cm³ to about 0.4 g/cm³, from about 0.15 g/cm³ to about 0.35 g/cm³, from about 0.20 g/cm³ to about 0.27 g/cm³, from about 0.24 g/cm³ to about 0.27 g/cm³, or alternatively from about 0.27 g/cm³ to about 0.32 g/cm³. In other instances, the products have a density of from about 0.02 to about 0.1 g/cm³ or from about 0.02 to about 0.05 g/cm³.

In addition to protein, the food products of the present invention may comprise other solid components (i.e., fillers) such as carbohydrates or fibers. The product may include filler in a ratio of filler to protein in the range of from about 5:95 to about 75:25. In certain embodiments, a majority of the filler is starch. Suitable starches include rice flour, potato, tapioca, and mixtures thereof.

Low density food products of the present invention typically contain water at a concentration of between about 1% and about 7% by weight of the food product and, more typically, between about 3% and about 5% by weight of the food product.

Various flavorings or spices can be added to or coated on the protein extrudate before drying. For example, acceptable flavoring agents include juices, spices, sugars, and the like. Particularly preferred flavoring agents include apple juice, lemon, lime, cane sugar, cheddar cheese, nacho flavoring, salsa, sour cream, barbeque, spices, and mixtures thereof. Typically, when a flavoring agent is added, the flavoring agent is present in the organic protein extrudate in an amount of from about 2% to about 25% by weight on a moisture-free basis; preferably, from about 2% to about 15% by weight; more preferably, from about 3% to about 8% by weight. The amount of flavoring agent added to the organic protein extrudate will generally depend on the desired end use of the organic protein extrudates.

### Meats

In various embodiments, the protein extrudate of the present invention is used in emulsified meats to provide structure to the emulsified meat, providing a firm bite and a meaty texture. The protein extrudate also decreases cooking loss of moisture from the emulsified meat by readily absorbing water, and prevents “fatting out” of the fat in the meat so the cooked meat is juicier.

The meat material used to form a meat emulsion in combination with the protein extrudate of the present invention is preferably a meat useful for forming sausages, frankfurters, or other meat products which are formed by filling a casing with a meat material, or can be a meat which is useful in ground meat applications such as hamburgers, meat loaf and minced meat products. Particularly preferred meat material used in combination with the protein extrudate includes mechanically deboned meat from chicken, beef, and pork; pork trimmings; beef trimmings; and pork backfat.

Typically, the ground protein extrudate is present in the meat emulsion in an amount of from about 0.1% to about 4% by weight, more typically from about 0.1% to about 3% by weight and, still more typically, from about 1% to about 3% by weight.

Typically, the meat material is present in the meat emulsion in an amount of from about 40% to about 95% by weight, more typically from about 50% to about 90% by weight and, still more typically, from about 60% to about 85% by weight.

The meat emulsion also contains water, which is typically present in an amount of from about 0.1% to about 25% by weight, more typically from about 0.1% to about 20% by weight, even more typically from about 0.1% to about 15% by weight and, still more typically, from about 0.1% to about 10% by weight.

The meat emulsion may also contain other ingredients that provide preservative, flavoring, or coloration qualities to the meat emulsion. For example, the meat emulsion may contain salt, typically from about 1% to about 4% by weight; spices, typically from about 0.1% to about 3% by weight; and preservatives such as nitrates, typically from about 0.001% to about 0.5% by weight.

### Beverages

The protein extrudate of the present invention may be used in beverage applications including, for example, acidic beverages. Typically, the ground protein extrudate is present in the beverage in an amount of from about 0.5% to about 3.5% by weight. The beverages in which the protein extrudate is incorporated typically contain from about 70% to about 90% by weight water, and may contain sugars (e.g., fructose and sucrose) in an amount of up to about 20% by weight.

### Extrusion Process

Extrusion cooking devices have long been used in the manufacture of a wide variety of edible and other products such as human and animal feeds. Generally speaking, these types of extruders include an elongated barrel together with one or more internal, helically flighted, axially rotatable extrusion screws therein. The outlet of the extruder barrel is equipped with an apertured extrusion die. In use, a material to be processed is passed into and through the extruder barrel and is subjected to increasing levels of temperature, pressure and shear. As the material emerges from the extruder die, it is fully cooked and shaped and may typically be subdivided using a rotating knife assembly. Conventional extruders of this type are described, for example, in U.S. Pat. Nos. 4,763,569, 4,118,164 and 3,117,006, which are incorporated herein by reference. Alternatively, the texturized protein product may be cut into smaller extrudates such as “nuggets” or powders for use as food ingredients.

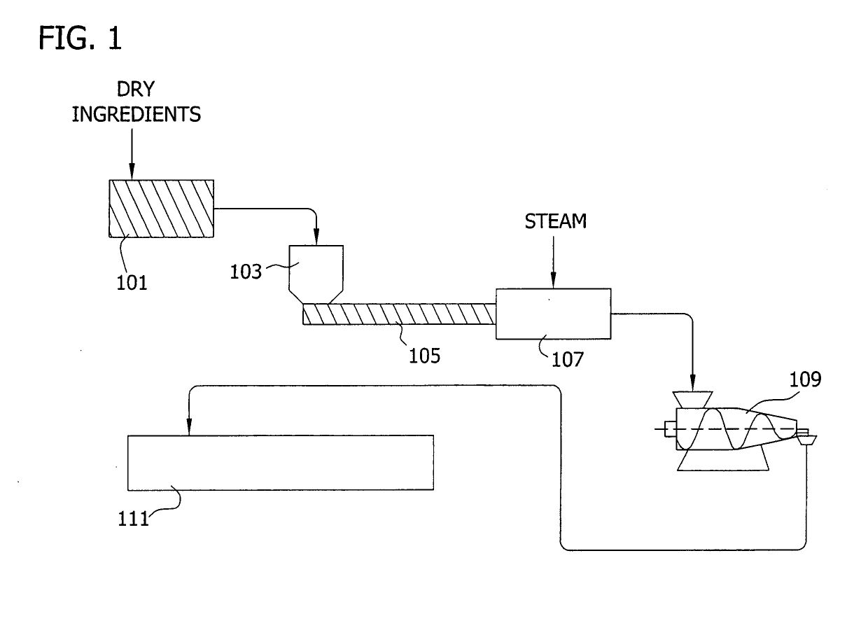

Referring now to FIG. 1, one embodiment of the process of the present invention is shown. The process comprises introducing the particular ingredients of the protein-containing feed mixture formulation into a mixing tank 101 (i.e., an ingredient blender) to combine the ingredients and form a protein feed pre-mix. The pre-mix is then transferred to a hopper 103 where the pre-mix is held for feeding via screw feeder 105 to a pre-conditioner 107 to form a conditioned feed mixture. The conditioned feed mixture is then fed to an extrusion apparatus (i.e., extruder) 109 in which the feed mixture is heated under mechanical pressure generated by the screws of the extruder to form a molten extrusion mass. The molten extrusion mass exits the extruder through an extrusion die.

In pre-conditioner 107, the particulate solid ingredient mix (i.e., protein feed pre-mix) is preheated, contacted with moisture, and held under controlled temperature and pressure conditions to allow the moisture to penetrate and soften the individual particles. The pre-conditioning step increases the bulk density of the particulate feed mixture and improves its flow characteristics. The pre-conditioner 107 contains one or more paddles to promote uniform mixing of the feed mixture and transfer of the feed mixture through the pre-conditioner. The configuration and rotational speed of the paddles vary widely, depending on the capacity of the pre-conditioner, the extruder throughput and/or the desired residence time of the feed mixture in the pre-conditioner or extruder barrel. Generally, the speed of the paddles is from about 500 to about 1300 revolutions per minute (rpm).

Typically, the protein-containing feed mixture is pre-conditioned prior to introduction into the extrusion apparatus 109 by contacting a pre-mix with moisture (i.e., steam and/or water) at a temperature of at least about 45° C. (110° F.). More typically, the feed mixture is conditioned prior to heating by contacting a pre-mix with moisture at a temperature of from about 45° C. (110° F.) to about 85° C. (185° F.). Still more typically, the feed mixture is conditioned prior to heating by contacting a pre-mix with moisture at a temperature of from about 45° C. (110° F.) to about 70° C. (160° F.). It has been observed that higher temperatures in the pre-conditioner may encourage starches to gelatinize, which in turn may cause lumps to form which may impede flow of the feed mixture from the pre-conditioner to the extruder barrel.

Typically, the pre-mix is conditioned for a period of about 1 to about 6 minutes, depending on the speed and the size of the conditioner. More typically, the pre-mix is conditioned for a period of from about 2 minutes to about 5 minutes, most typically about 3 minutes. The pre-mix is contacted with steam and/or water and heated in the pre-conditioner 107 at generally constant steam flow to achieve the desired temperatures. The water and/or steam conditions (i.e., hydrates) the feed mixture, increases its density, and facilitates the flowability of the dried mix without interference prior to introduction to the extruder barrel where the proteins are texturized. In certain embodiments, the feed mixture pre-mix is contacted with both water and steam to produce a conditioned feed mixture. For example, experience to date suggests that it may be preferable to add both water and steam to increase the density of the dry mix as steam contains moisture to hydrate the dry mix and also provides heat which promotes hydration of the dry mix by the water.

The conditioned pre-mix may contain from about 5% to about 25% by weight water. Preferably, the conditioned pre-mix contains from about 5% to about 15% by weight water. The conditioned pre-mix typically has a bulk density of from about 0.25 g/cm³ to about 0.6 g/cm³. Generally, as the bulk density of the pre-conditioned feed mixture increases within this range, the feed mixture is easier to convey and further to process. This is presently believed to be due to such mixtures occupying all or a majority of the space between the screws of the extruder, thereby facilitating conveying the extrusion mass through the barrel.

The conditioned pre-mix is generally introduced to the extrusion apparatus 109 at a rate of about 10 kilograms (kg)/min (20 lbs/min). In some of the various embodiments, the conditioned pre-mix is introduced to the barrel at a rate of from about 2 to about 10 kg/min (from about 5 to about 20 lbs/min), more typically from about 5 to about 10 kg/min (from about 10 to about 20 lbs/min) and, still more typically, from about 6 to about 8 kg/min (from about 12 to about 18 lbs/min). Generally, it has been observed that the density of the extrudate decreases as the feed rate of pre-mix to the extruder increases. The residence time of the extrusion mass in the extruder barrel is typically less than about 60 seconds, more typically less than about 30 seconds and, still more typically, from about 15 seconds to about 30 seconds.

Typically, extrusion mass passes through the barrel at a rate of from about 7.5 kg/min to about 40 kg/min (from about 17 lbs/min to about 85 lbs/min). More typically, extrusion mass passes through the barrel at a rate of from about 7.5 kg/min to about 30 kg/min (from about 17 lbs/min 65 lbs/min). Still more typically, extrusion mass passes through the barrel at a rate of from about 7.5 kg/min to about 22 kg/min (from about 17 lbs/min to about 50 lbs/min). Even more typically, extrusion mass passes through the barrel at a rate of 7.5 kg/min to about 15 kg/min (from about 17 lbs/min to about 35 lbs/min). Usually the amount of mass going throughout the extruder will be driven by the size and configuration of the extruder.

Various extrusion apparatus suitable for forming a molten extrusion mass from a feed material comprising vegetable protein are well known in the art. One suitable extrusion apparatus is a double-barrel, twin screw extruder as described, for example, in U.S. Pat. No. 4,600,311. Examples of commercially available double-barrel, twin screw extrusion apparatus include a CLEXTRAL Model BC-72 extruder manufactured by Clextral, Inc. (Tampa, Fla.) having an L/D ratio of 13.5:1 and four barrel zones; a WENGER Model TX-57 extruder manufactured by Wenger (Sabetha, Kans.) having an L/D ratio of 14:1 and four barrel zones; and a WENGER Model TX-52 extruder manufactured by Wenger (Sabetha, Kans.) having an L/D ratio of 13.5:1 and four barrel zones. Other suitable extruders include CLEXTRAL Models Evolum 68, BC-82, and BC-92 and WENGER Models TX-138, TX-144, TX-162, and TX-168.

The ratio of the length and diameter of the extruder (L/D ratio) generally determines the length of extruder necessary to process the mixture and affects the residence time of the mixture therein. Generally the L/D ratio is greater than about 10:1, greater than about 15:1, greater than about 20:1, or even greater than about 25:1.

The screws of a twin screw extruder can rotate within the barrel in the same or opposite directions. Rotation of the screws in the same direction is referred to as single flow whereas rotation of the screws in opposite directions is referred to as double flow.

The speed of the screw or screws of the extruder may vary depending on the particular apparatus. However, the screw speed is typically from about 250 to about 400 revolutions per minute (rpm), more typically from about 260 to about 380 rpm and, still more typically, from about 270 to about 370 rpm. Generally, as the screw speed increases, the density of the extrudates decreases.

The extrusion apparatus 109 generally comprises a plurality of barrel zones through which feed mixture is conveyed under mechanical pressure prior to exiting the extrusion apparatus 109 through an extrusion die. The temperature in each successive barrel zone generally exceeds the temperature of the previous heating zone by between about 10° C. and about 70° C. (between about 15° F. and about 125° F.), more generally by between about 10° C. and about 50° C. (from about 15° F. to about 90° F.) and, more generally, from about 10° C. to about 30° C. (from about 15° F. to about 55° F.).

For example, the temperature in the last barrel zone is from about 90° C. to about 150° C. (from about 195° F. to about 300° F.), more typically from about 100° C. to about 150° C. (from about 212° F. to about 300° F.) and, still more typically, from about 100° C. to about 130° C. (from about 210° F. to about 270° F.). The temperature in the next to last barrel zone is, for example, from about 80° C. to about 120° C. (from about 175° C. to about 250° C.) or from about 90° C. to about 110° C. (from about 195° F. to about 230° F.). In some embodiments, the temperature in the barrel zone immediately before the next to last barrel zone is from about 70° C. to about 100° C. (from about 160° F. to about 210° F.) and preferably, from about 80° C. to about 90° C. (from about 175° F. to about 195° F.). Typically, the temperature in the barrel zone separated from the last heating zone by two heating zones is from about 50° C. to about 90° C. (from about 120° F. to about 195° F.) and, more typically, from about 60° C. to about 80° C. (from about 140° F. to about 175° F.).

Typically, the extrusion apparatus comprises at least about three barrel zones and, more typically, at least about four barrel zones. In a preferred embodiment, the conditioned pre-mix is transferred through four barrel zones within the extrusion apparatus, with the feed mixture is heated to a temperature of from about 100° C. to about 150° C. (from about 212° F. to about 302° F.) such that the molten extrusion mass enters the extrusion die at a temperature of from about 100° C. to about 150° C. (from about 212° F. to about 302° F.).

In such an embodiment, the first heating zone is preferably operated at a temperature of from about 50° C. to about 90° C. (from about 120° F. to about 195° F.), the second heating zone is operated at a temperature of from about 70° C. to about 100° C. (from about 160° F. to about 212° F.), the third heating zone is operated at a temperature of from about 80° C. to about 120° C. (from about 175° F. to about 250° F.) and the fourth heating zone is operated at a temperature of from about 90° C. to about 150° C. (from about 195° F. to about 302° F.).

The temperature within the heating zones may be controlled using suitable temperature control systems including, for example, Mokon temperature control systems manufactured by Clextral (Tampa, Fla.) or electric heating. Steam may also be introduced to one or more heating zones via one or more valves in communication with the zones to control the temperature. Another alternative is the use oil Mokon unit heated by electric resistance or steam. Some extruders don't have external heating system; the extruder barrel temperatures can be achieved by the shear generated in the system; higher shear will generate greater temperatures. Extruders not having heating system will have cooling water running in the barrel zones; this is to control the energy and temperatures generated by the extruder shear.

Apparatus used to control the temperature of the barrel zones may be automatically controlled. One such control system includes suitable valves (e.g., solenoid valves) in communication with a programmable logic controller (PLC).

The pressure within the extruder barrel is not narrowly critical. Typically the extrusion mass is subjected to a pressure of at least about 400 psig (about 28 bar) and generally the pressure within the last two heating zones is from about 1000 psig to about 3000 psig (from about 70 bar to about 210 bar). The barrel pressure is dependent on numerous factors including, for example, the extruder screw speed, feed rate of the mixture to the barrel, die flow area, feed rate of water to the barrel, and the viscosity of the molten mass within the barrel.

The heating zones within the barrel may be characterized in terms of the action upon the mixture therein. For example, zones in which the primary purpose is to convey the mixture longitudinally along the barrel, mix, compress the mixture, or provide shearing of the proteins are generally referred to as conveying zones, mixing zones, compression zones, and shearing zones, respectively. It should be understood that more than one action may occur within a zone; for example, there may be “shearing/compression” zones or “mixing/shearing” zones. The action upon the mixture within the various zones is generally determined by various conditions within the zone including, for example, the temperature of the zone and the screw profile within the zone.

The extruder is characterized by its screw profile which is determined, at least in part, by the length to pitch ratio of the various portions of the screw. Length (L) indicates the length of the screw while pitch (P) indicates the distance required for 1 full rotation of a thread of the screw. In the case of a modular screw containing a plurality of screw portions having varying characteristics, L can indicate the length of such a portion and P the distance required for 1 full rotation of a thread of the screw. The intensity of mixing, compression, and/or shearing generally increases as the pitch decreases and, accordingly, L:P increases. L:P ratios for the twin-screws within the various heating zones of one embodiment of the present invention are provided below in Table 2.

TABLE 2

| Zone | L:P | Flow |
|---|---|---|
| Conveying | 200/100 | Double flow |
| Conveying | 200/100 | Double flow |
| Conveying | 150/100 | Double flow |
| Compression | 200/66 | Double flow |
| Compression | 200/66 | Double flow |
| Shearing | 100/50 | Double flow |
| Shearing | 100/40 | Single flow |
| Shearing | 100/30 (reverse) | Single flow |

Water is injected into the extruder barrel to hydrate the feed mixture and promote texturization of the proteins. As an aid in forming the molten extrusion mass the water may act as a plasticizing agent. Water may be introduced to the extruder barrel via one or more injection jets. Typically, the mixture in the barrel contains from about 15% to about 30% by weight water. The rate of introduction of water to any of the barrel zones is generally controlled to promote production of an extrudate having desired characteristics. It has been observed that as the rate of introduction of water to the barrel decreases, the density of the extrudate decreases. Typically, less than about 1 kg of water per kg of protein are introduced to the barrel and, more typically less than about 0.5 kg of water per kg of protein and, still more typically, less than about 0.25 kg of water per kg of protein are introduced to the barrel. Generally, from about 0.1 kg to about 1 kg of water per kg of protein are introduced to the barrel.

Referring again to FIG. 1, the molten extrusion mass in extrusion apparatus 109 is extruded through a die (not shown) to produce an extrudate, which is then dried in dryer 111.

Extrusion conditions are generally such that the product emerging from the extruder barrel typically has moisture content of from about 15% to about 45% by weight wet basis and, more typically, from about 20% to about 40% by weight wet basis. The moisture content is derived from water present in the mixture introduced to the extruder, moisture added during preconditioning and/or any water injected into the extruder barrel during processing.

Upon release of pressure, the molten extrusion mass exits the extruder barrel through the die, superheated water present in the mass flashes off as steam, causing simultaneous expansion (i.e., puffing) of the material. The level of expansion of the extrudate upon exiting of mixture from the extruder in terms of the ratio of the cross-sectional area of extrudate to the cross-sectional area of die openings is generally less than about 15:1, more generally less than about 10:1 and, still more generally, less than about 5:1. Typically, the ratio of the cross-sectional area of extrudate to the cross-sectional area of die openings is from about 2:1 to about 11:1 and, more typically, from about 2:1 to about 10:1. The puffed material will form a shape that is generally driven by the geometry of the die to form extruded ropes.

The extrudate mass/ropes are cut after exiting the die to obtain the proper characteristics in the puffed material. Suitable apparatus for cutting the extrudate include flexible knives manufactured by Wenger (Sabetha, Kans.) and Clextral (Tampa, Fla.).

The dryer 111 used to dry the extrudates generally comprises a plurality of drying zones in which the air temperature may vary. Generally, the temperature of the air within one or more of the zones will be from about 135° C. to about 185° C. (from about 280° F. to about 370° F.). Typically, the temperature of the air within one or more of the zones is from about 140° C. to about 180° C. (from about 290° F. to about 360° F.), more typically from about 155° C. to 170° C. (from about 310° F. to 340° F.) and, still more typically, from about 160° C. to about 165° C. (from about 320° F. to about 330° F.). Typically, the extrudate is present in the dryer for a time sufficient to provide an extrudate having desired moisture content. This desired moisture content may vary widely depending on the intended application of the extrudate and, typically, is from about 2.5% to about 6.0% by weight. Generally, the extrudate is dried for at least about 5 minutes and, more generally, for at least about 10 minutes. Suitable dryers include those manufactured by Wolverine Proctor & Schwartz (Merrimac, Mass.), National Drying Machinery Co. (Philadelphia, Pa.), Wenger (Sabetha, Kans.), Clextral (Tampa, Fla.), and Buehler (Lake Bluff, Ill.).

The extrudates may further be comminuted to reduce the average particle size of the extrudate. Suitable grinding apparatus include hammer mills such as Mikro Hammer Mills manufactured by Hosokawa Micron Ltd. (England).

### Definitions and Methods

TNBS. Trinitrobenzene sulfonic acid (TNBS) reacts under controlled conditions with the primary amines of proteins to produce a chromophore which absorbs light at 420 nm. The intensity of color produced from the TNBS-amine reaction is proportional to the total number of amino terminal groups and therefore is an indicator of the degree of hydrolysis of a sample. Such measurement procedures are described, for example, by Adler-Nissen in J. Agric. Food Chem., Vol. 27(6), p. 1256 (1979).

Degree of Hydrolysis. Percent (%) degree of hydrolysis is determined from the TNBS value using the following equation: % degree of hydrolysis=((TNBSᵥₐₗᵤₑ−24)/885)×100. The value, 24, is the correction for lysyl amino group of a non-hydrolyzed sample and the value, 885, is the moles of amino acid per 100 kg of protein.

Protein Content. The Nitrogen-Ammonia-Protein Modified Kjeldahl Method of A.O.C.S. Methods Bc4-91 (1997), Aa 5-91 (1997), and Ba 4d-90(1997) can be used to determine the protein content of a soy material sample.

Nitrogen Content. The nitrogen content of the sample is determined according to the formula: Nitrogen (%)=1400.67×[[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample for soy protein.

Extent of Gelation. Gel strength, expressed in terms of the extent of gelation (G) may be determined by preparing a slurry (commonly 200 grams of a slurry having a 1:5 weight ratio of soy protein source to water) to be placed in an inverted frustoconical container which is placed on its side to determine the amount of the slurry that flows from the container. The container has a capacity of aply 150 ml (5 ounces), height of 7 cm, top inner diameter of 6 cm, and a bottom inner diameter of 4 cm. The slurry sample of the soy protein source may be formed by cutting or chopping the soy protein source with water in a suitable food cutter including, for example, a Hobart Food Cutter manufactured by Hobart Corporation (Troy, Ohio). The extent of gelation, G, indicates the amount of slurry remaining in the container over a set period of time. Low viscosity/low gelling sources of soy protein suitable for use in accordance with the present invention typically exhibit an extent of gelation, on a basis of 200 grams of sample introduced to the container and taken five minutes after the container is placed on its side, of from about 1 gram to about 80 grams (i.e., from about 1 gram to about 80 grams, 0.5% to about 40%, of the slurry remains in the container five minutes after the container is placed on its side). High viscosity/medium to high gelling sources of soy protein suitable for use in accordance with the present invention typically exhibit an extent of gelation, on the same basis described above, of from about 45 grams to about 140 grams (i.e., from about 45 grams to about 140 grams, 22% to about 70%, of the slurry remains in the container five minutes after the container is placed on its side). A blend of sources comprising a low viscosity/low gelling source and a high viscosity/high gelling source typically have a gelation rate, on the same basis, of from about 20 grams to about 120 grams.

Color Value. Color intensity of the protein extrudate is measured using a color-difference meter such as a Hunterlab colorimeter to obtain a color L value, a color A value, and a color B value.

Moisture Content. The term “moisture content” as used herein refers to the amount of moisture in a material. The moisture content of a soy material can be determined by A.O.C.S. (American Oil Chemists Society) Method Ba 2a-38 (1997), which is incorporated herein by reference in its entirety. Moisture content is calculated according to the formula: Moisture content (%)=100×[(loss in mass (grams)/mass of sample (grams)].

Texture. To measure the texture, a Stable Micro Systems Model TA-XT2i with 50 kg load cell is used. The sample to be tested is placed in the back extrusion rig and place it on the platform. The test is conducted by inserting a probe into the sample to a vertical distance of 68 mm. The hardness of the sample is measured by the force needed to advance the probe. When a 3 compression test is performed, the same sample is subjected to three successive measurements.

Having described the invention in detail, it will be apparent that modifications and variations are possible without departing from the scope of the invention defined in the appended claims.

### EXAMPLES

The following non-limiting examples are provided to further illustrate the present invention.

### Example 1

### Organic Soy Protein Extrudates Having 15-60% by Weight Soy Protein

This example illustrates the preparation of organic soy protein extrudates comprising 15%, 25%, 30%, 40%, 50%, and 60% (by wt.) organic soy protein using various feed mixture formulations.

The feed mixtures are described below in Table 3. The weights of the components are represented in % by weight on a moisture-free basis. Alpha® 6800 was available from Solae, LLC (St. Louis, Mo.). Native Tapioca Starch was available from Avebe Corp. (Princeton, N.J.). Dicalcium Phosphate was available from Astaris Food Phosphates (Webster Groves, Mo.).

TABLE 3

| | Product | | | | | |
|---|---|---|---|---|---|---|
| | S1.1 | S1.2 | S1.3 | S1.4 | S1.5 | S1.6 |
| | (15% | (25% | (30% | (40% | (50% | (60% |
| Feed Mixture | Protein) | Protein) | Protein) | Protein) | Protein) | protein) |
| Alpha ® 6800 | 15.4 | 30.8 | 46.2 | 61.5 | 76.9 | 92.3 |
| Rice Flour | 84.2 | 68.8 | 53.4 | 38.1 | — | — |
| Tapioca starch | — | — | — | — | 22.7 | 7.2 |
| Dicalcium PO4 | 0.3 | 0.3 | 0.3 | 0.3 | 0.3 | 0.3 |
| NaCl | 0.1 | 0.1 | 0.1 | 0.1 | 0.1 | 0.1 |

The ingredients of each feed mixture were mixed in an ingredient blender for 40 minutes to ensure uniform distribution. The dry feed mixture was pneumatically conveyed to a volumetric feeder (i.e., hopper) and fed to a pre-conditioning tank at a rate of 0.80 to 1.10 kg/min (1.76-2.42 lb/min) in which the dry mix was pre-conditioned with steam and water. Water was introduced to the pre-conditioner at a rate of 0.07 to 0.25 kg/min (0.15-0.55 lb/min) and steam was injected into a conditioning tank at a rate of 0.05 to 0.15 kg/min (0.11-0.33 lb/min). The mixture in the pre-conditioner was continuously stirred with a paddle rotating at 680-730 rpm and the flow of steam was carefully monitored to maintain the temperature of the protein mixture within the pre-conditioner between about 60° and about 70.5° C. (140° F.-160° F.).

The dry mix was then introduced to the inlet of the extruder barrel inlet by a conveyor. Conditioned feed mix was introduced into the extruder at a rate of 0.80 to 1.10 kg/min (1.76 to 2.42 lb/min) using an extruder screw speed of from 270 to 800 rpm.

The extruder used was a double-barrel, twin-screw extruder, WENGER Model TX-52 manufactured by Wenger (Sabetha, Kans.) having an L/D ratio of 13.5:1 and four heating zones. The screw profile for the extruder is described in Table 4.

TABLE 4

| Length | Pitch |
|---|---|
| 200 | 100 |
| 200 | 100 |
| 150 | 100 |
| 200 | 66 |
| 200 | 66 |
| 100 | 50 |
| 100 | 40 |
| 100 | 30* |

| Zone | L:P | Flow |
|---|---|---|
| Conveying | 200/100 | Double flow |
| Conveying | 200/100 | Double flow |
| Conveying | 150/100 | Double flow |
| Compression | 200/66 | Double flow |
| Compression | 200/66 | Double flow |
| Shearing | 100/50 | Double flow |
| Shearing | 100/40 | Single flow |
| Shearing | 100/30 (reverse) | Single flow |

*Reverse

Water was introduced into the extruder barrel at a rate of 0.17 to 0.30 kg/min (0.37-0.66 lb/min) without steam injection. The barrel temperatures were controlled with a Mokon temperature control system manufactured by Clextral (Tampa, Fla.). The extruder contains 4 heating zones through which the feed mixture passed. The temperature profile of the TX-52 extruder is shown in Table 5 below.

TABLE 5

| | | | | Extrusion |
|---|---|---|---|---|
| | Extrusion | Extrusion | Extrusion | Zone 4 |
| Pre-conditioner | Zone 1 | Zone 2 | Zone 3 | (Die end) |
| 60-70° C. | 20-30° C. | 40-80° C. | 80-115° C. | 100-130° C. |
| (140-158° F.) | (68-86° F.) | (104-176° F.) | (176-239° F.) | (212-266° F.) |

The conditioned feed mix was cooked in the extruder barrel with mechanical energy generated from the extruder screw rpm/shear and electrical energy at high temperatures to reach the glass transition temperature. At high temperatures, shear, and pressure the feed mix melted and interacted with water and other ingredients to form a plastic material which was then extruded through a backup plate having a diameter of about 0.125 inches (3.125 mm) diameter before passing through an extrusion die (1.5 mm or 2 mm or 3 mm diameter holes).

The organic protein extrudates were cut using a 6 bladed knife rotating at 1500-3500 rpm to obtain the product size, density and granulation. The die knife area was ventilated by sparging compressed air (within the cutter guard) to aid face plate cooling/product cutting.

Some organic protein extrudates were spray coated with apple juice and/or cane sugar prior to coating to improve the flavor of the organic protein extrudates for use in food products such as breakfast cereals. The extrudates were sprayed with 2 to 6% fruit/or cane juice with a Spray Coating System from Spray Dynamics.

The organic soy protein extrudates were dried with a Proctor single band conveyor dryer (Proctor & Schartz, SCM Corporation, Philadelphia, Pa.) at a temperature of from about 115° C. to about 136° C. (240° F. to about 277° F.) for a residence time of 10-20 minutes. The dried organic soy protein extrudates were sieved using #3 and #8 Sweco sieves to remove the fines.

Some of the dried organic protein extrudates were then spray coated with a 90%/10% soybean oil/cheddar cheese mixture and then coated with one of several flavoring agents selected from barbecue, hot and spicy barbecue, nacho flavoring, sour cream, cheddar cheese.

The dried organic protein extrudates were then analyzed for final composition. The results are shown below in Table 6.

TABLE 6

| | S1.1 | S1.2 | S1.3 | S1.4 | S1.5 | S1.6 |
|---|---|---|---|---|---|---|
| | (15% Protein) | (25% Protein) | (30% Protein) | (40% Protein) | (50% Protein) | (60% Protein) |
| Final | | | | | | |
| Composition: | | | | | | |
| Protein (wt. %) | 16.1 | 25.4 | 33.9 | 43.0 | 49.0 | 58.8 |
| Moisture (wt. %) | 1.4 | 1.4 | 1.4 | 1.5 | 1.5 | 1.4 |
| Fat (wt. %) | 2.3 | 4.7 | 8.1 | 11.2 | 13.8 | 17.7 |
| Ash (wt. %) | 1.4 | 2.2 | 2.8 | 3.62 | 4.4 | 5.1 |
| Calcium (wt. %) | 0.105 | 0.163 | 0.174 | 0.217 | 0.238 | 0.244 |
| Sodium (wt. %) | 0.102 | 0.156 | 0.170 | 0.180 | 0.191 | 0.199 |
| Dietary Fiber: | | | | | | |
| Insoluble Dietary | 1.07 | 1.70 | 4.09 | 4.14 | 4.66 | 4.79 |
| Fiber (wt. %) | | | | | | |
| Soluble Dietary | 1.13 | 1.56 | 1.96 | 2.46 | 3.09 | 3.11 |
| Fiber (wt. %) | | | | | | |
| Total Dietary | 2.21 | 3.26 | 6.06 | 6.60 | 7.75 | 7.90 |
| Fiber (wt. %) | | | | | | |
| Sugar Profile: | | | | | | |
| Fructose (wt. %) | <0.200 | <0.200 | <0.200 | <0.200 | <0.200 | <0.200 |
| Glucose (wt. %) | <0.200 | <0.200 | <0.200 | <0.200 | <0.200 | <0.200 |
| Lactose (wt. %) | <0.200 | <0.200 | <0.200 | <0.200 | <0.200 | <0.200 |
| Maltose (wt. %) | <0.200 | <0.200 | <0.200 | <0.200 | <0.200 | <0.200 |
| Sucrose (wt. %) | 0.660 | 1.06 | 1.55 | 1.95 | 2.32 | 2.63 |
| Raffinose (wt. %) | <0.200 | <0.200 | <0.200 | <0.200 | <0.200 | <0.200 |
| Stachyose (wt. %) | 0.350 | 0.780 | 1.180 | 1.190 | 1.920 | 1.950 |

As shown in Table 6, the concentrations of fat, total dietary fiber, ash, and protein increased with an increase in the concentration of organic soy protein concentrate used in the feed mixture. As such, food products made with the organic protein extrudates produced in this Example would provide a good source of dietary fiber, fat, protein, and calcium.

Additionally, the hardness of the organic protein extrudates was determined using a texture analyzer, Model # TA.TXT2 with a 25 kg load cell manufactured by Stable Micro Systems Ltd. (England) as described herein above. Additionally, the color value (e.g., “L”, “a”, and “b”) and particle size distribution of the organic protein extrudates were also evaluated using the methods described herein above. The density, hardness, color values, and particle size distribution of the various organic soy protein extrudates are summarized below in Table 7.

TABLE 7

| | | S1.2 | | | | |
|---|---|---|---|---|---|---|
| | S1.1 (15% | (25% | S1.3 (30% | S1.4 (40% | S1.5 (50% | S1.6 (60% |
| | Protein) | Protein) | Protein) | Protein) | Protein) | Protein) |
| Density (g/cm³) | 0.245 | 0.214 | 0.228 | 0.301 | 0.362 | 0.524 |
| Color - L Value | 67.90 | 62.08 | 59.77 | 58.11 | 55.15 | 52.5 |
| Color - a Value | 1.17 | 2.88 | 3.83 | 4.43 | 5.55 | 7.2 |
| Color - b Value | 22.56 | 23.15 | 23.21 | 23.66 | 22.70 | 23.3 |
| Granulation (%) | | | | | | |
| U.S. #4 | 3.10 | 12.79 | 10.73 | 1.49 | 2.75 | 0.00 |
| U.S. #6 | 92.18 | 86.57 | 88.24 | 97.74 | 91.10 | 0.00 |
| U.S. #8 | 4.75 | 0.56 | 0.95 | 0.79 | 6.14 | 83.71 |
| pan | 0.04 | 0.03 | 0.04 | 0.02 | 0.01 | 16.18 |
| Texture (grams) | 10,807.4 | 6,411.1 | 5,725.67 | 12,706.68 | 16,810.04 | 15,074.36 |

### Example 2

### Organic Soy Protein Nuggets Having 50-90 wt. % Protein

This example illustrates the preparation of organic protein extrudates made from combinations of various concentrations of organic isolated soy proteins and organic soy protein concentrates. The feed mixtures are described below in Table 8. Soy Protein Isolate, Soy-N-ergy was available from Soy Quick-American Health & Nutrition (Ann Arbor, Mich.). Alpha® 6800 was available from Solae, LLC (St. Louis, Mo.). Native Tapioca Starch was available from Avebe Corp. (Princeton, N.J.). Dicalcium Phosphate was available from Astaris Food Phosphates (Webster Groves, Mo.). Soy Lecithin Powder, from Solae, LLC

(St. Louis, Mo.). Units for the components are % by weight on a moisture-free basis.

TABLE 8

| | S2.1 | S2.2 | S2.3 | S2.4 | S2.5 | S2.6 | S2.7 |
|---|---|---|---|---|---|---|---|
| | (50% | (50% | (60% | (60% | (70% | (80% | (90% |
| Feed Mixture: | protein) | protein) | protein) | protein) | protein) | protein) | protein) |
| Soy-N-ergy ISP | 34.7 | 34.7 | 46.1 | 46.1 | 67.4 | 90.0 | 99.15 |
| Alpha ® 6800 | 29.4 | 29.4 | 29.4 | 29.4 | 15.0 | — | — |
| Nat. Tapioca Starch | — | 35.6 | — | 24.2 | 16.75 | 9.15 | — |
| Rice Flour | 35.6 | — | 24.2 | — | — | — | — |
| Dicalcium Phosphate | 0.3 | 0.3 | 0.3 | 0.3 | 0.5 | 0.5 | 0.5 |
| Soy Lecithin | — | — | — | — | 0.3 | 0.3 | 0.3 |
| L-Cysteine HCl | — | — | — | — | 0.05 | 0.05 | 0.05 |

The procedure as described in Example 1 was used to produce final products (extrudates).

The dried organic protein extrudates were then analyzed for final composition. The results are shown below in Table 9.

TABLE 9

| | S2.1 | S2.2 | S2.3 | S2.4 | S2.5 | | |
|---|---|---|---|---|---|---|---|
| | (50% | (50% | (60% | (60% | (70% | S2.6 | S2.7 |
| Final | pro- | pro- | pro- | pro- | pro- | (80% | (90% |
| Composition: | tein) | tein) | tein) | tein) | tein) | protein) | protein) |
| Protein (wt. %) | 54.60 | 54.30 | 62.30 | 61.90 | 69.10 | 79.70 | 88.50 |
| Moisture (wt. %) | 0.87 | 0.48 | 0.62 | 0.78 | 0.68 | 0.70 | 0.53 |
| Fat (wt. %) | 5.62 | 5.36 | 7.32 | 6.75 | 6.69 | 5.30 | 5.37 |
| Ash (wt. %) | 3.43 | 3.60 | 4.20 | 4.36 | 4.88 | 4.98 | 5.33 |

The density, hardness, color values, and particle size distribution of the various organic soy protein extrudates are summarized below in Table 10.

TABLE 10

| | S2.1 | S2.2 | S2.3 | S2.4 | S2.5 | S2.6 | S2.7 |
|---|---|---|---|---|---|---|---|
| | (50% | (50% | (60% | (60% | (70% | (80% | (90% |
| | protein) | protein) | protein) | protein) | protein) | protein) | protein) |
| Density (g/cm³) | 0.285 | 0.188 | 0.298 | 0.267 | 0.375 | 0.386 | 0.397 |
| Color - L Value | 55.45 | 53.56 | 51.58 | 51.49 | 51.46 | 56.47 | 50.80 |
| Color - a Value | 4.40 | 4.52 | 5.04 | 5.07 | 4.70 | 3.77 | 5.06 |
| Color - b Value | 21.23 | 20.38 | 21.00 | 21.27 | 20.27 | 21.26 | 20.21 |
| Granulation (%) | | | | | | | |
| U.S. #4 | 13.72 | 23.16 | 12.39 | 24.74 | 0.21 | 0.05 | 0.03 |
| U.S. #6 | 85.16 | 76.78 | 87.54 | 73.67 | 81.68 | 3.04 | 11.94 |
| U.S. #8 | 1.26 | 0.29 | 0.51 | 1.66 | 17.64 | 93.57 | 86.60 |
| pan | 0.06 | 0.04 | 0.02 | 0.12 | 0.30 | 0.44 | 0.09 |
| Texture (grams) | 28,217.0 | 20,700.1 | 29,063.7 | 19,505.2 | 37,695.9 | 38,677.7 | 37,248.1 |

### Example 3

### Organic Protein Extrudates Having 30-60 wt. % Protein

This example illustrates the preparation of organic protein extrudates made from combinations of various concentrations of organic isolated soy proteins and organic soy flours. The feed mixtures are described below in Table 11. Soy Protein Isolate, Soy-N-ergy was available from Soy Quick-American Health & Nutrition (Ann Arbor, Mich.). Soy Flour was available from Solae, LLC (St. Louis, Mo.). Native Tapioca Starch was available from Avebe Corp. (Princeton, N.J.). Dicalcium Phosphate was available from Astaris Food Phosphates (Webster Groves, Mo.). All ingredient measurements are in % by weight on a moisture-free basis.

TABLE 11

| | S3.1 | S3.2 | S3.3 | S3.4 | S3.5 | S3.6 | S3.7 |
|---|---|---|---|---|---|---|---|
| | (30% | (40% | (40% | (50% | (50% | (60% | (60% |
| | pro- | pro- | pro- | pro- | pro- | pro- | pro- |
| Feed Mixture | tein) | tein) | tein) | tein) | tein) | tein) | tein) |
| Soy-N-ergy ISP | — | 22.7 | 22.7 | 33.3 | 33.3 | 56.8 | 56.8 |
| Soy Flour | 54.5 | 40.0 | 40.0 | 40.0 | 40 | 20.0 | 20.0 |
| Rice Flour | 45.2 | 37.0 | — | 26.7 | — | 22.9 | — |
| Nat. Tapioca Starch | — | — | 37.0 | — | 26.7 | — | 22.9 |
| Dicalcium Phosphate | 0.3 | 0.3 | 0.3 | 0.3 | 0.3 | 0.3 | 0.3 |

The procedure of Example 1 was used to produce protein extrudates and the dried organic protein extrudates were then analyzed for final composition. The results are shown below in Table 12.

TABLE 12
The Proximate Composition of Supro ® 620 NAP/Soy Flour Crisps.

| | Moisture | Protein | Fat | Ash | Calcium | Sodium |
|---|---|---|---|---|---|---|
| | (%) | (%) | (%) | (%) | (%) | (%) |
| S3.1-Supro ® 620 NAP/Soy Flour Rice - 30% | 4.70 | 32.70 | 6.04 | 3.16 | 0.23 | 0.127 |
| S3.2-Supro ® 620 NAP/Soy Flour Rice - 40% | 4.05 | 37.50 | 5.44 | 3.64 | 0.50 | 0.788 |
| S3.3-Supro ® 620 NAP/Soy Flour Tapioca - 40% | 4.02 | 37.80 | 5.44 | 3.67 | 0.48 | 0.809 |
| T4-Supro ® 620 NAP/Soy Flour Rice - 50% | 3.56 | 48.50 | 6.40 | 4.44 | 0.68 | 0.110 |
| S3.5-Supro ® 620 NAP/Soy Flour Tapioca - 50% | 3.57 | 48.40 | 5.44 | 4.20 | 0.63 | 0.112 |
| S3.6-Supro ® 620 NAP/Soy Flour Rice - 60% | 3.05 | 57.60 | 5.13 | 4.63 | 0.83 | 0.147 |
| S3.7-Supro ® 620 NAP/Soy Flour Tapioca - 60% | 2.56 | 58.30 | 4.25 | 4.67 | 0.93 | 0.164 |

The density, hardness, color values, and particle size distribution of the various organic soy protein extrudates are summarized below in Table 13.

TABLE 13
The Physical Properties of Supro ® 620 NAP/Soy Flour Crisps.

| | S3.1 | S3.2 | S3.3 | S3.4 | S3.5 | S3.6 | T7 |
|---|---|---|---|---|---|---|---|
| | 30% | 40% | 40% | 50% | 50% | 60% | 60% |
| | Protein | Protein | Protein | Protein | Protein | Protein | Protein |
| | Rice | Rice | Tapioca | Rice | Tapioca | Rice | Tapioca |
| | Flour | Flour | St. | Flour | St. | Flour | St. |
| Density Average (g/cc) | 0.2584 | 0.2547 | 0.2370 | 0.2992 | 0.3003 | 0.3261 | 0.2850 |
| Density Average | 16.12 | 15.89 | 14.79 | 18.67 | 18.74 | 20.35 | 17.78 |
| (lb.cu.ft.) | | | | | | | |
| Color: | | | | | | | |
| L Value | 60.05 | 60.43 | 60.17 | 59.60 | 60.22 | 59.02 | 57.07 |
| A Value | 2.07 | 1.41 | 1.49 | 2.34 | 2.23 | 1.89 | 2.34 |
| B Value | 24.27 | 19.54 | 19.52 | 21.24 | 21.23 | 18.66 | 18.12 |
| Granulation (%): | | | | | | | |
| US #4 ON | 43.79 | 0.09 | 46.63 | 0.41 | 0.69 | 0.87 | 8.58 |
| US #6 ON | 84.14 | 68.43 | 53.16 | 99.07 | 98.88 | 87.08 | 84.14 |
| US #8 ON | 7.18 | 0.85 | 0.31 | 0.65 | 0.53 | 12.60 | 7.18 |
| PAN | 0.31 | 0.07 | 0.18 | 0.04 | 0.04 | 0.27 | 0.31 |
| Texture: | | | | | | | |
| Crushed Force (grams) | 9212 | 36280 | 38246 | 36210 | 27757 | 37367 | 32119 |

### Example 4

### Organic Soy Protein Extrudates Having 70% by Weight Protein

This example illustrates the preparation of organic protein extrudates comprising 70% (by wt.) organic protein made from various concentrations of organic isolated soy proteins. The feed mixtures are described below in Table 14. SUPRO® 8000 was available from Solae, LLC (St. Louis, Mo.). Supro® 248 was available from Solae, LLC (St. Louis, Mo.). Native Tapioca Starch was available from Avebe Corp. (Princeton, N.J.). Dicalcium Phosphate was available from Astaris Food Phosphates (Webster Groves, Mo.).

TABLE 14

| | S4.1 | S4.2 | | S4.4 |
|---|---|---|---|---|
| | (70% | (70% | S4.3 | (70% |
| Feed Mixture | protein) | protein) | (70% protein) | protein) |
| SUPRO ® 8000 | 66.2 | 66.2 | 66.2 | 75.5 |
| FXP H0347 | 13.3 | 13.3 | 13.3 | — |
| Rice Flour | 20.2 | — | — | — |
| Corn Flour | — | 20.2 | — | — |
| Oat Flour | — | — | 8.0 | 20.2 |
| Tapioca Starch | — | — | 12.2 | — |
| Dicalcium Phosphate | 0.2 | 0.2 | 0.2 | 0.3 |
| Salt (NaCl) | 0.1 | 0.1 | 0.1 | — |

The procedure of Example 1 was used to produce protein extrudates and the dried organic protein extrudates are then analyzed for final composition. The results are shown below in Table 15.

TABLE 15

| | S4.1 | | S4.3 | |
|---|---|---|---|---|
| | (70% | S4.2 | (70% | S4.4 |
| Final Composition: | protein) | (70% protein) | protein) | (70% protein) |
| Protein (wt. %) - | 69.3 | 69.9 | 70.6 | 73.5 |
| Moisture (wt. %) | 5.7 | 4.9 | 4.4 | 3.9 |
| Fat (wt. %) - | 4.5 | 4.3 | 3.7 | 5.4 |
| Ash (wt. %) | 3.6 | 3.5 | 3.6 | 4.0 |

The density, hardness, color values, and particle size distribution of the various organic soy protein extrudates are summarized below in Table 16.

TABLE 16

| | S4.1 | S4.2 | S4.3 | S4.4 |
|---|---|---|---|---|
| | (70% | (70% | (70% | (70% |
| | protein) | protein) | protein) | protein) |
| Density (g/cm³) | 0.217 | 0.202 | 0.232 | 0.284 |
| Color - L Value | 57.24 | 56.30 | 54.28 | 55.03 |
| Color - a Value | 2.52 | 2.74 | 2.91 | 2.09 |
| Color - b Value | 19.27 | 20.32 | 18.71 | 17.59 |
| Granulation (%) - | 0.2 | 0.4 | 0.4 | 0.0 |
| U.S. #4 | | | | |
| Granulation (%) - | 98.8 | 98.7 | 94.4 | 66.9 |
| U.S. #6 | | | | |
| Granulation (%) - | 1.3 | 1.3 | 5.5 | 32.6 |
| U.S. #8 | | | | |
| Granulation (%) - | 0.3 | 0.3 | 0.2 | 0.7 |
| pan | | | | |
| Texture (grams) | 11,845.0 | 9,457.0 | 12,981.0 | 26,344.0 |

### Example 5

### Food Bars Comprising Organic Soy Protein Extrudates

This example illustrates the preparation of high protein food bars comprising organic soy protein extrudates comprising 60% (by weight) protein and sugar syrups. Additionally, this example evaluates the overall appearance, flavor, texture, firmness, and mouth feel of the high protein food bars as compared to high protein food bars comprising conventional soy protein extrudates.

The feed mixtures to produce the organic soy protein extrudates are described below in Table 17. SUPRO® Plus 60 was a 60% soy protein nugget processed with Supro® 8000/Supro® 620 or Supro® 8000/Supro® 248 and was available from Solae, LLC (St. Louis, Mo.). FXP H0320 was a hydrolyzed soy protein isolate with 90% protein (moisture free basis) for bars. Soy Flour was available from The Solae Company (St. Louis, Mo.). Rice Flour was available from Pacific Grain Products, Inc. (Woodland, Calif.). Native Tapioca Starch was available from Avebe Corp. (Princeton, N.J.). Dicalcium Phosphate was available from Astaris Food Phosphates (Webster Groves, Mo.).

TABLE 17
Formulations for 60% Organic Soy Protein Nuggets or Crisps.

| | Product | | | |
|---|---|---|---|---|
| | SUPRO | | | |
| | PLUS ® | Sample 1 | Sample 2 | Sample 3 |
| | 60 (60% | (60% | (60% | (60% |
| Feed Mixture: | protein) | protein) | protein) | Protein) |
| ISP (Soy-N-ergy | — | 46.1 | 46.1 | 46.1 |
| ISP 90) | | | | |
| Alpha ® 6800 | — | 29.4 | 29.4 | 29.4 |
| Supro ® 8000 | 51.7 | — | — | — |
| Supro ® 620 | 17.3 | — | — | — |
| Rice Flour | 30.7 | 24.2 | — | — |
| Tapioca Starch | — | — | 24.2 | 24.2 |
| Dicalcium | — | 0.3 | 0.3 | 0.3 |
| Phosphate | | | | |
| Sodium Chloride | 0.3 | — | — | — |

Protein extrudates were produced using the procedure of Example 1.

Some of the dried organic soy protein extrudates are then spray coated with a lemon flavoring agent (available from Flavorettes Lemon, Quali Tech, Inc., Chaska, Minn.). The flavoring agent was added by using 3 wt. % to 8 wt. % of flavoring sprayed on nuggets or included in the formulations for sheet-and-cut bars.

The dried organic soy protein extrudates were then analyzed for final composition. The results are shown below in Table 18.

TABLE 18A
Proximate Composition of 60% Organic Soy Protein Nuggets or Crisps.

| | Moisture | Protein | Fat | Ash |
|---|---|---|---|---|
| | (%) | (%) | (%) | (%) |
| T1 - Supro ® Nuggets 60 | 3.27 | 60.4 | 3.6 | 3.3 |
| T2 - Soy-N-ergy/Alpha ® 6800 60% | 0.62 | 62.3 | 7.3 | 4.2 |
| T3 - Soy-N-ergy/Alpha ® 6800 60% | 0.80 | 61.9 | 6.8 | 4.4 |
| T4 - Soy-N-ergy/Alpha ® 6800 60% | 0.50 | 60.0 | 6.9 | 3.8 |

TABLE 18B
Physical Properties of 60% Organic Soy Protein Nuggets or Crisps

| | T1 | | | |
|---|---|---|---|---|
| | Supro Nugget | T2 | T3 | T4 |
| | 60 | 60% Protein | 60% Protein | 60% Protein |
| Density | 0.213 | 0.298 | 0.267 | 0.280 |
| Average | | | | |
| (g/cc) | | | | |
| Density | 13.3 | 18.6 | 16.7 | 17.5 |
| Average | | | | |
| (lb.cu.ft.) | | | | |
| Color: | | | | |
| L Value | 56.22 | 51.58 | 51.49 | 56.03 |
| A Value | 3.37 | 5.04 | 5.07 | 4.38 |
| B Value | 20.84 | 21.00 | 21.27 | 21.37 |
| Granulation | | | | |
| (%): | | | | |
| US # 4 ON | 5.53 | 12.39 | 24.74 | 13.72 |
| US # 6 ON | 94.32 | 87.54 | 73.67 | 85.16 |
| US # 8 ON | 0.11 | 0.51 | 1.66 | 1.26 |
| PAN | 0.04 | 0.02 | 0.29 | 0.09 |
| Texture: | | | | |
| Hardness | 15824.3 | 29063.7 | 19505.2 | 25541.9 |
| Force | | | | |
| (grams) | | | | |

Once the lemon-flavored organic soy protein extrudates were produced, high protein food bars were produced using the extrudates. Specifically, to obtain the high protein food bars, a first mixture containing about 1500.00 grams organic soy protein extrudate produced above, 1472.00 grams rice syrup solids (available as 26 DE from Natural Products, Lathrop, Calif.), 489.00 grams cocoa powder (available from DeZaan, a division of Archer Daniels Midland, Decatur, Ill.), 66.00 grams vitamin and mineral premix (available from Fortitech, Inc. Schenectady, N.Y.), 12.00 grams salt (NaCl), 51.00 grams Cellulose Novagel BK2131 (available from FMC BioPolymer, Philadelphia, Pa.), and 216.00 grams Cellulose Novagel BK2132 (available from FMC BioPolymer, Philadelphia, Pa.) was mixed using a Hobart mixer for one minute. Then, a second mixture containing liquid sugar syrups and liquid flavoring agents was heated to a temperature of 43.3° C. (110° F.) by microwaving on high power for about 4 minutes. The liquid sugar syrup consisted of 3881.00 grams of a 55:45 blend of 63 DE corn syrup (available from Roquette, LESTREM Cedex, France) to high fructose corn syrup 55 (available from International Molasses Corp., Rochelle Park, N.J.). The liquid flavoring agents consisted of 169.00 grams Chocolate Liquor (available from Blommer, Inc., Chicago, Ill.), 28.00 grams Centrophase CS lecithin (available from Solae, LLC, St. Louis, Mo.), 471.00 grams maltitol (available from Roquette America Inc., and Allied Starch & Chemical, Keokuk, Iowa), 28.00 grams Edlong Chocolate flavor 610 (available from The Edlong Corporation, Elk Grove Village, Ill.), 28.00 grams Edlong Chocolate flavor 614 (available from The Edlong Corporation, Elk Grove Village, Ill.), and 14.00 grams vanilla flavoring (available from Sethness Greenleaf, Inc., Chicago, Ill.). The heated second mixture was then mixed with the first mixture in a Hobart mixer at a speed of 48 rpm for aply one to two minutes. The resulting dough was then sheeted out onto a marble slab and bars are cut into pieces weighing about 36 grams (the bar pieces are ½″ in length, 4″ in height, and 1⅜″ wide).

Four samples of high protein food bars comprising the various organic protein extrudates were made. One sample was made by using the SUPRO® Plus 60 extrudates and the other three samples were made using a single type of organic soy protein extrudate each as produced above. The samples were analyzed and evaluated for various taste and texture properties using 61 trained panelists. To evaluate the samples, each high protein food bar sample was cut into 3 pieces with the ends removed and served to the panelists on 6″ coded white plates. Specifically, acceptance scales ranking overall liking, liking of appearance, liking of flavor, liking of texture (i.e., mouthfeel), and liking of firmness, are measured using a 9-point hedonic scale. According to the 9-point hedonic scale, a score of 9 is extreme liking and a score of 0 is extreme disliking. Additionally, perception scales, such as perception of overall flavor, amount of aftertaste, firmness/hardness perception and chewiness perception, are also measured using a 5-point hedonic scale. According to the 5-point hedonic scale, a score of 5 is extremely strong flavor, strong aftertaste, too firm/hard, and too chewy, and a score of 0 is extremely weak flavor, no aftertaste perceived, too soft and not chewy enough. The results of the panel tasting are shown in Table 19.

TABLE 19

| | | | | | | Perception | | | |
|---|---|---|---|---|---|---|---|---|---|
| | | | Liking | Liking | | of | | Firmness/ | |
| | Overall | Liking of | of | of | Liking of | Overall | Amount of | Hardness | Chewiness |
| Sample | Liking | Appearance | Flavor | Texture | Firmness | Flavor | Aftertaste | Perception | Perception |
| SUPRO ® Plus 60 | 6.07 | 7.03 | 6.02 | 5.74 | 5.57 | 6.39 | 6.50 | 6.50 | 5.83 |
| extrudate sample | | | | | | | | | |
| Sample 1 | 6.00 | 7.00 | 6.00 | 5.80 | 5.90 | 6.86 | 6.73 | 6.69 | 5.74 |
| extrudate sample | | | | | | | | | |
| Sample 2 | 6.30 | 7.00 | 6.10 | 6.00 | 6.00 | 6.78 | 6.62 | 6.84 | 5.72 |
| extrudate sample | | | | | | | | | |
| Sample 3 | 6.50 | 7.10 | 6.50 | 6.30 | 6.40 | 6.66 | 6.88 | 6.84 | 6.37 |
| extrudate sample | | | | | | | | | |

As shown in Table 19, the samples of bars containing organic soy protein scored at parity or significantly higher than the bars containing SUPRO Plus 60 extrudates on all acceptance scales. As such, health conscious consumers can consume high protein food bars containing organic soy protein without sacrificing taste and texture.

### Example 6

### Alpha® 6800 Organic Soy Protein Extrudates

Protein extrudates were prepared generally according to the process described in Example 1 and using the following extrusion parameters.

| | | Organic | Organic | | |
|---|---|---|---|---|---|
| | | Soy | Soy | Organic | Organic |
| | | Nuggets or | Nuggets or | TVP - | TVP - |
| Formulation Information | | Crisps | Crisps | Chunks | Shreds |
| Extrusion Parameters | | Wenger | Clextral | Wenger | Wenger |
| | | TX-52 | Evolum 68 | TX-52 | TX-52 |
| Dry Formula Feed Rate | (kg/hr) | 50-80 | 300-500 | 60-80 | 60-80 |
| Dry Feed Rate Bulk Density | (kg/m3) | 300-600 | 300-600 | 300-600 | 300-600 |
| Cylinder Steam | (kg/hr) | 3.0-6.0 | 6-10 | — | — |
| Cylinder Water | (kg/hr) | 3.0-8.0 | 22-42 | 10-20 | 10-20 |
| Extruder Water | (kg/hr) | 8.0-16.0 | 50-80 | 1-10 | 1-10 |
| Cylinder Paddle Speed | RPM or % | 230-270 | 50-80 | 250-350 | 250-350 |
| | | | (%) | | |
| Extruder Screw Speed | RPM | 300-800 | 500-800 | 300-500 | 300-500 |
| Knife Speed | RPM | 800-1600 | 300-500 | 5-150 | 5-150 |
| Feeder Screw Speed | RPM | 40-50 | 35-90 | 50-80 | 50-80 |
| SME (Specific Mech. | kwh/hr | 150-200 | — | 40-100 | 40-100 |
| Energy) | | | | | |
| Down Spout Temperature | (° C.) | 50-70 | 50-70 | 30-50 | 30-50 |
| Zone #1 Temperature | (° C.) | 40-60 | 10-40 | 40-60 | 40-60 |
| Zone #2 Temperature | (° C.) | 60-80 | 50-60 | 60-80 | 60-80 |
| Zone #3 Temperature | (° C.) | 80-130 | 60-70 | 80-130 | 80-130 |
| Zone #4 Temperature | (° C.) | 90-120 | 80-100 | 90-120 | 90-120 |
| Zone #5 Temperature | (° C.) | — | 60-70 | — | — |
| Zone #1 Pressure | (PSI) | — | — | — | — |
| Zone #2 Pressure | (PSI) | — | — | — | — |
| Zone #3 Pressure | (PSI) | — | — | — | — |
| Head Pressure | (PSI) | 100-500 | — | 100-500 | 100-500 |
| Fitzmill: | | — | — | — | — |
| Sieve Cutter size | | — | — | — | 0.5″ or |
| | | | | | 0.250″ |
| National Dryer Information | | — | — | — | — |
| Dryer Belt Setting | | 4-12 | 3-6 | 2-5 | 2-5 |
| Temperature of the Dryer- | (° F.) | 240-300 | 330-350 | 240-300 | 240-300 |
| Zone 1 | | | | | |
| Temperature of the Dryer- | (° F.) | — | 310-330 | — | — |
| Zone 2 | | | | | |
| Temperature of the Dryer- | (° F.) | — | — | — | — |
| Zone 3 | | | | | |
| Time in the Dryer | (min) | 10-20 | 7-15 | 40-60 | 20-40 |
| Tray Dryer Information | | — | — | — | — |
| Dryer Setting | | — | — | — | — |
| Temperature of the Dryer | (° F.) | — | — | 240-300 | — |
| Time in the Dryer | (min) | — | — | 20-30 | — |

Die Configuration

| | | | | | |
|---|---|---|---|---|---|
| Spacer | 6.35 mm | | 55372-719 | | |
| | (0.25 in.) | | | | |
| Insert holder | | | 55372-159 | | |
| Insert: | | | | | |
| Organic Soy Protein | | | | w/back plate | 9 holes/3 mm |
| | | | | | (dia.) |
| Nuggets | 1.5 mm; 2.0 mm | | | | |
| | Diameter | | | | |
| | 1 × 3; 1 × 4 mm | | | | |
| Organic TVP | 13.0 mm Diameter | | | | |
| Chunks | | | | | |
| Organic TVP Shreds | 13.0 mm Diameter | Fizmill: | | | |
| | | 0.5″ or 0.25″ | | | |

Knife Configuration

| | | | |
|---|---|---|---|
| Knife holder | | | 55226-003 |
| Y-adapter | | | 55361-9 |
| Knife blades | 6 blades-Nuggets | 1 Blade-TVP | |
| Knife shaft | 182 mm (total length) | | |

The formulations, composition, and physical characteristics of the protein extrudates are described in the tables below.

TABLE 20A
The Formulations for Alpha ® 6800 Soy
Crisps.

| | S6.1 | S6.2 | S6.3 |
|---|---|---|---|
| | 50% Protein | 55% Protein | 60% Protein |
| Alpha ® 6800 | 76.6 | 84.3 | 92.0 |
| Tapioca Starch | 22.8 | 15.1 | 7.2 |
| Dicalcium Phosphate | 0.3 | 0.3 | 0.5 |
| Soy Lecithin | 0.3 | 0.3 | 0.3 |

TABLE 20B
The Composition of Ground Alpha ® 6800 Soy Crisps.

| | Moisture | Protein | Fat | Ash |
|---|---|---|---|---|
| | (%) | (%) | (%) | (%) |
| S6.1. Alpha 6800 ® 50% | 3.07 | 49.4 | 11.9 | 4.21 |
| S6.2. Alpha 6800 ® 55% | 4.17 | 54.3 | 14.2 | 4.57 |
| S6.3. Alpha 6800 ® 60% | 4.68 | 58.1 | 15.3 | 4.79 |

TABLE 20C
The Physical Properties of Alpha ® 6800 Soy Crisps.

| | S6.1 | S6.2 | S6.3 |
|---|---|---|---|
| | 50% | 55% | 60% |
| | Protein | Protein | Protein |
| Density Average (g/cc) | 0.2817 | 0.3795 | 0.3948 |
| Density Average | 17.58 | 23.68 | 24.64 |
| (lb.cu.ft.) | | | |
| Color: | | | |
| L Value | 55.19 | 55.68 | 54.18 |
| A Value | 4.80 | 4.83 | 5.48 |
| B Value | 22.34 | 22.50 | 19.08 |
| Granulation (%): | | | |
| US # 4 ON | 5.85 | 0.18 | 0.12 |
| US # 6 ON | 93.44 | 89.03 | 29.14 |
| US # 8 ON | 0.77 | 10.70 | 69.57 |
| PAN | 0.01 | 0.06 | 0.83 |
| Texture: | | | |
| Crushed Force (grams) | 15016 | 26753 | 38375 |

### Example 7

### Alpha® 6800/Supro® 8000 Soy Protein Crisps

Protein extrudates were prepared generally according to the process described in Example 1 and using the extrusion parameters in Example 6. The formulations, composition, and physical characteristics of the protein extrudates are described in the tables below.

TABLE 21A
The Formulations for Alpha ® 6800/Supro ® 8000 Crisps.

| | | | | S7.4 |
|---|---|---|---|---|
| | S7.1 | S7.2 | S7.3 | 70% |
| | 50% Protein | 55% Protein | 60% Protein | Protein |
| Alpha ® 6800 | 53.0 | 57.9 | 53.4 | 17.4 |
| Supro ® 8000 | 23.4 | 23.4 | 29.0 | 67.0 |
| Tapioca Starch | 22.8 | 18.1 | 17.0 | 15.0 |
| Dicalcium | 0.3 | 0.3 | 0.3 | 0.3 |
| Phosphate | | | | |
| Soy Lecithin | 0.3 | 0.3 | 0.3 | 0.3 |

TABLE 21B
The Composition of Alpha ® 6800/Supro ® 8000 Crisps.

| | Mois- | | | |
|---|---|---|---|---|
| | ture | Protein | Fat | Ash |
| | (%) | (%) | (%) | (%) |
| S7.1. Alpha ® 6800/Supro ® 8000 50% | 4.54 | 55.00 | 8.37 | 3.96 |
| S7.2. Alpha ® 6800/Supro ® 8000 55% | 3.20 | 58.40 | 10.10 | 4.12 |
| S7.3. Alpha ® 6800/Supro ® 8000 60% | 3.48 | 60.00 | 11.10 | 4.09 |
| S7.4. Alpha ® 6800/Supro ® 8000 70% | 2.11 | 71.00 | 6.69 | 3.89 |

TABLE 21C
The Physical Properties of Alpha ® 6800/Supro ® 8000 Crisps.

| | S7.1 | S7.2 | S7.3 | S7.4 |
|---|---|---|---|---|
| | 50% | 55% | 60% | 70% |
| | Protein | Protein | Protein | Protein |
| Density Average | 0.2584 | 0.2766 | 0.2617 | 0.2208 |
| (g/cc) | | | | |
| Density Average | 16.12 | 17.26 | 16.33 | 13.78 |
| (lb.cu.ft.) | | | | |
| Color: | | | | |
| L Value | 55.26 | 55.80 | 55.58 | 54.31 |
| A Value | 4.09 | 4.08 | 3.94 | 3.02 |
| B Value | 21.28 | 21.45 | 19.08 | 19.47 |
| Granulation (%): | | | | |
| US # 4 ON | 53.56 | 36.95 | 50.72 | 91.86 |
| US # 6 ON | 46.25 | 63.11 | 49.27 | 8.12 |
| US # 8 ON | 0.24 | 0.02 | 0.01 | 0.00 |
| PAN | 0.06 | 0.04 | 0.03 | 0.19 |
| Texture: | | | | |
| Crushed Force | 7116 | 12368 | 10093 | 10205 |
| (grams) | | | | |

### Example 8

### Supro® 620 NAP Soy Protein Crisps

Protein extrudates were prepared generally according to the process described in Example 1 and using the extrusion parameters in Example 6. The formulations, composition, and physical characteristics of the protein extrudates are described in the tables below.

TABLE 22A
The Formulations for Supro ® 620 NAP Extruded Soy Crisps

| | S8.1 | | | |
|---|---|---|---|---|
| | 55% | S8.2 | S8.3 | S8.4 |
| | Protein | 60% Protein | 65% Protein | 70% Protein |
| Supro ® 620 NAP | 58.1 | 64.0 | 69.5 | 81.1 |
| Rice Flour | 41.6 | 35.7 | 30.2 | — |
| Tapioca Starch | — | — | — | 18.6 |
| Soy Lecithin | 0.3 | 0.3 | 0.3 | 0.3 |

TABLE 22B
The Composition of Ground Supro ® 620 NAP Extruded Soy Crisps.

| | Moisture | Protein | Fat | Ash |
|---|---|---|---|---|
| | (%) | (%) | (%) | (%) |
| S8.1. Supro ® 620 NAP 55% | 2.53 | 57.60 | 3.23 | 4.17 |
| S8.2. Supro ® 620 NAP 60% | 2.66 | 60.70 | 2.83 | 4.27 |
| S8.3. Supro ® 620 NAP 65% | 3.45 | 64.20 | 3.11 | 4.57 |
| S8.4. Supro ® 620 NAP 70% | 4.51 | 73.30 | 2.99 | 5.11 |

TABLE 22C
The Physical Properties of Supro ® 620 NAP Extruded Soy Crisps.

| | S8.1 | S8.2 | S8.3 | S8.4 |
|---|---|---|---|---|
| | 55% | 60% | 65% | 70% |
| | Protein | Protein | Protein | Protein |
| Density Average (g/cc) | 0.247 | 0.245 | 0.278 | 0.307 |
| Density Average | 15.4 | 15.3 | 17.4 | 19.2 |
| (lb.cu.ft.) | | | | |
| Color: | | | | |
| L Value | 58.12 | 56.20 | 53.85 | 50.78 |
| A Value | 2.03 | 2.36 | 2.66 | 3.17 |
| B Value | 17.13 | 16.40 | 16.15 | 15.22 |
| Granulation (%): | | | | |
| US # 4 ON | 4.43 | 6.97 | 3.78 | 3.04 |
| US # 6 ON | 79.90 | 74.50 | 75.28 | 74.07 |
| US # 8 ON | 15.62 | 18.07 | 20.85 | 22.47 |
| PAN | 0.04 | 0.47 | 0.09 | 0.42 |
| Texture: | | | | |
| Crushed Force (grams) | 24422.14 | 22416.2 | 20651.85 | 16212.01 |

### Example 9

### Soy-N-ergy® ISP and Soy-N-ergy® ISP/Alpha® 6800 Soy Protein Crisps

Protein extrudates were prepared generally according to the process described in Example 1 and using the extrusion parameters in Example 6. The formulations, composition, and physical characteristics of the protein extrudates are described in the tables below.

TABLE 23A
The Formulations for Soy-N-ergy ® ISP and Soy-N-ergy ®
ISP/Alpha ® 6800 Crisps.

| | S9.1 | S9.2 | | |
|---|---|---|---|---|
| | 55% | 60% | S9.3 | S9.4 |
| | Protein | Protein | 55% Protein | 60% Protein |
| Soy-N-ergy ® ISP | 62.5 | 68.2 | 29.0 | 53.1 |
| Alpha ® 6800 | — | — | 45.4 | 29.0 |
| Rice Flour | 36.9 | 31.2 | 25.0 | 17.3 |
| Soy Lecithin | 0.3 | 0.3 | 0.3 | 0.3 |
| Dicalcium Phosphate | 0.3 | 0.3 | 0.3 | 0.3 |

TABLE 23B
The Composition of Soy-N-ergy ® ISP and Soy-N-ergy ®
ISP/Alpha ® 6800 Crisps.

| | Moisture | Protein | Fat | Ash |
|---|---|---|---|---|
| | (%) | (%) | (%) | (%) |
| S9.1. Soy-N-ergy ® ISP - 55% | 3.39 | 58.70 | 5.66 | 2.63 |
| S9.2. Soy-N-ergy ® ISP - 60% | 3.09 | 64.10 | 5.79 | 2.77 |
| S9.3 Soy-N-ergy ® | 4.85 | 58.40 | 10.50 | 3.71 |
| ISP/Alpha ® 6800 - 55% | | | | |
| S9.4. Soy-N-ergy ® | 6.55 | 60.50 | 10.60 | 3.86 |
| ISP/Alpha ® 6800 - 60% | | | | |

TABLE 23C
The Physical Properties of Soy-N-ergy ® ISP and Soy-N-ergy ®
ISP/Alpha ® 6800 Crisps.

| | S9.1 | S9.2 | S9.3 | S9.4 |
|---|---|---|---|---|
| | 55% | 60% | 55% | 60% |
| | Protein | Protein | Protein | Protein |
| Density Average (g/cc) | 0.281 | 0.313 | 0.322 | 0.347 |
| Density Average | 17.5 | 19.5 | 20.1 | 21.7 |
| (lb.cu.ft.) | | | | |
| Color: | | | | |
| L Value | 56.26 | 55.50 | 55.89 | 54.72 |
| A Value | 3.67 | 3.94 | 4.45 | 4.89 |
| B Value | 20.84 | 20.89 | 22.37 | 22.49 |
| Granulation (%): | | | | |
| US # 4 ON | 14.50 | 0.81 | 0.74 | 0.50 |
| US # 6 ON | 84.98 | 98.36 | 99.17 | 99.23 |
| US # 8 ON | 0.50 | 0.79 | 0.09 | 0.27 |
| PAN | 0.02 | 0.04 | 0.00 | 0.00 |
| Texture: | | | | |
| Crushed Force (grams) | 20981.38 | 23362.48 | 19582 | 15671.27 |

### Example 10

### Supro® 620 NAP/Soy Flour Soy Protein Crisps

Protein extrudates were prepared generally according to the process described in Example 1 and using the extrusion parameters in Example 6. The formulations, composition, and physical characteristics of the protein extrudates are described in the tables below.

TABLE 24A
The Formulation for Supro ® 620 NAP/Soy Flour Crisps.

| | S10.1 | S10.2 | S10.3 | S10.4 | | | |
|---|---|---|---|---|---|---|---|
| | 30% | 40% | 40% | 50% | S10.5 | S10.6 | S10.7 |
| | Pro- | Pro- | Pro- | Pro- | 50% | 60% | 60% |
| | tein | tein | tein | tein | Protein | Protein | Protein |
| Supro ® 620 | — | 22.7 | 22.7 | 33.3 | 33.3 | 56.8 | 56.8 |
| NAP | | | | | | | |
| Soy flour | 54.5 | 40.0 | 40.0 | 40.0 | 40 | 20.0 | 20.0 |
| Rice flour | 45.2 | 37.0 | — | 26.7 | — | 22.9 | — |
| Tapioca starch | — | — | 37.0 | — | 26.7 | — | 22.9 |
| Dicalcium | 0.3 | 0.3 | 0.3 | 0.3 | 0.3 | 0.3 | 0.3 |
| phosphate | | | | | | | |

TABLE 24B
The Composition of Supro ® 620 NAP/Soy Flour Crisps.

| | Moisture | Protein | Fat | Ash | Calcium | Sodium |
|---|---|---|---|---|---|---|
| | (%) | (%) | (%) | (%) | (%) | (%) |
| S10.1. Supro ® 620/Soy Flour Rice - | 4.70 | 32.70 | 6.04 | 3.16 | 0.23 | 0.127 |
| 30% | | | | | | |
| S10.2. Supro ® 620/Soy Flour Rice - | 4.05 | 37.50 | 5.44 | 3.64 | 0.50 | 0.788 |
| 40% | | | | | | |
| S10.3. Supro ® 620/Soy Flour | 4.02 | 37.80 | 5.44 | 3.67 | 0.48 | 0.809 |
| Tapioca - 40% | | | | | | |
| S10.4. Supro ® 620/Soy Flour Rice - | 3.56 | 48.50 | 6.40 | 4.44 | 0.68 | 0.110 |
| 50% | | | | | | |
| S10.5. Supro ® 620/Soy Flour | 3.57 | 48.40 | 5.44 | 4.20 | 0.63 | 0.112 |
| Tapioca - 50% | | | | | | |
| S10.6. Supro ® 620/Soy Flour Rice - | 3.05 | 57.60 | 5.13 | 4.63 | 0.83 | 0.147 |
| 60% | | | | | | |
| S10.7. Supro ® 620/Soy Flour | 2.56 | 58.30 | 4.25 | 4.67 | 0.93 | 0.164 |
| Tapioca - 60% | | | | | | |

TABLE 24C
The Physical Properties of Supro ® 620 NAP/Soy Flour Crisps.

| | S10.1 | S10.2 | S10.3 | S10.4 | S10.5 | S10.6 | S10.7 |
|---|---|---|---|---|---|---|---|
| | 30% | 40% | 40% | 50% | 50% | 60% | 60% |
| | Protein | Protein | Protein | Protein | Protein | Protein | Protein |
| Density Average | 0.2584 | 0.2547 | 0.2370 | 0.2992 | 0.3003 | 0.3261 | 0.2850 |
| (g/cc) | | | | | | | |
| Density Average | 16.12 | 15.89 | 14.79 | 18.67 | 18.74 | 20.35 | 17.78 |
| (lb.cu.ft.) | | | | | | | |
| Color: | | | | | | | |
| L Value | 60.05 | 60.43 | 60.17 | 59.60 | 60.22 | 59.02 | 57.07 |
| A Value | 2.07 | 1.41 | 1.49 | 2.34 | 2.23 | 1.89 | 2.34 |
| B Value | 24.27 | 19.54 | 19.52 | 21.24 | 21.23 | 18.66 | 18.12 |
| Granulation (%): | | | | | | | |
| US # 4 ON | 43.79 | 0.09 | 46.63 | 0.41 | 0.69 | 0.87 | 8.58 |
| US # 6 ON | 84.14 | 68.43 | 53.16 | 99.07 | 98.88 | 87.08 | 84.14 |
| US # 8 ON | 7.18 | 0.85 | 0.31 | 0.65 | 0.53 | 12.60 | 7.18 |
| PAN | 0.31 | 0.07 | 0.18 | 0.04 | 0.04 | 0.27 | 0.31 |
| Texture: | | | | | | | |
| Crushed Force | 9212 | 36280 | 38246 | 36210 | 27757 | 37367 | 32119 |
| (grams) | | | | | | | |

### Example 11

### Supro® 8000 NAP/Supro® 620 NAP Soy Protein Crisps

Protein extrudates were prepared generally according to the process described in Example 1 and using the extrusion parameters in Example 6. The formulations, composition of, and physical characteristics of the protein extrudates are described in the tables below.

TABLE 25A
The Formulations for Organic Crisps.

| | S11.1 | S12.2 | S12.3 | S12.4 |
|---|---|---|---|---|
| | 60% | 60% | 60% | 70% |
| | Protein | Protein | Protein | Protein |
| Soless H102 | 38.0 | 58.0 | 63.0 | 73.0 |
| Soless G101 | 37.0 | 18.0 | 12.0 | 15.0 |
| Rice Flour | 25.0 | 25.0 | 25.0 | 0.0 |
| Tapioca Starch | 0.0 | 0.0 | 0.0 | 25.0 |

TABLE 25B
The Composition of Organic Crisps.

| | Moisture | Protein | Fat | Ash | Calcium | Sodium |
|---|---|---|---|---|---|---|
| | (%) | (%) | (%) | (%) | (%) | (%) |
| S11.1. Soless ® H102/Soless ® | 4.38 | 57.60 | 5.36 | 4.81 | 0.962 | 0.389 |
| G101 1:1 | | | | | | |
| S11.2. Soless ® H102/Soless ® | 4.76 | 57.10 | 7.66 | 5.01 | 1.16 | 0.402 |
| G101 3:1 | | | | | | |
| S11.3. Soless ® H102/Soless ® | 2.88 | 58.10 | 8.01 | 5.31 | 1.20 | 0.409 |
| G101 5:1 | | | | | | |
| S11.4. Soless ® H102/Soless ® | 3.23 | 67.20 | 9.06 | 5.64 | 1.40 | 0.511 |
| G101 5:1 | | | | | | |

TABLE 25C
The Physical Properties of Organic Crisps.

| | S11.1 | S11.2 | S11.3 | S11.4 |
|---|---|---|---|---|
| | 60% | 60% | 60% | 70% |
| | Protein | Protein | Protein | Protein |
| Density Average (g/cc) | 0.262 | 0.265 | 0.207 | 0.299 |
| Density Average | 16.33 | 16.53 | 12.94 | 18.68 |
| (lb.cu.ft.) | | | | |
| Color: | | | | |
| L Value | 53.89 | 52.44 | 57.16 | 53.34 |
| A Value | 4.11 | 4.45 | 3.94 | 4.36 |
| B Value | 19.59 | 19.81 | 21.44 | 20.48 |
| Granulation (%): | | | | |
| US # 4 ON | 28.56 | 15.32 | 0.09 | 9.16 |
| US # 6 ON | 66.58 | 78.27 | 81.79 | 76.65 |
| US # 8 ON | 4.20 | 5.89 | 1.87 | 12.05 |
| PAN | 0.73 | 0.58 | 0.94 | 2.18 |
| Texture: | | | | |
| Crushed Force (grams) | 19866.15 | 19588.57 | 35722.74 | 43772.32 |
| Compression Force (kg): | | | | |
| First Compression | 29.6 | 21.8 | 21.1 | 37.1 |
| Second Compression | 19.3 | 15.5 | 17.8 | 32.2 |
| Third Compression | 21.7 | 16.6 | 17.9 | 32.2 |

### Example 12

### Soless® G101/Soless® H102 Soy Protein Nuggets or Crisps

Protein extrudates were prepared generally according to the process described in Example 1 and using the extrusion parameters in Example 6. The formulations, composition, and physical characteristics of the protein extrudates are described in the tables below.

TABLE 26A
Formulations for Organic Soy Protein Nuggets or Crisps with
Soless ® G101/Soless ® H102 Ratios (60% Protein).

| | Control | | S12.2 | S12.3 | S12.4 | |
|---|---|---|---|---|---|---|
| | S8000/ | S12.1 | SG101/ | SG101/ | SG101/ | S12.5 |
| | S620 | Soless ® | SH102 | SH102 | SH102 | Soless ® |
| | 3:1 | G101 | 3:1 | 1:1 | 1:3 | H102 |
| | (%) | (%) | (%) | (%) | (%) | (%) |
| Supro ® 8000 | 51.0 | — | — | — | — | — |
| Supro ® 620 | 17.0 | — | — | — | — | — |
| Soless ® G101 (Supro 620 | — | 78.0 | 43.5 | — | — | — |
| NAP 1) | | | | | | |
| Soless ® G101 (Supro 620 | — | — | 15.0 | 39.0 | 19.5 | — |
| NAP 2) | | | | | | |
| Soless ® H102 (S 8000 NAP- | — | — | 19.5 | 39.0 | — | — |
| TNBS 65) | | | | | | |
| Soless ® H102 (S 8000 NAP- | — | — | — | — | 58.5 | 78.0 |
| TNBS 38) | | | | | | |
| Corn Flour | — | 22.0 | 22.0 | 22.0 | 22.0 | 22.0 |
| Rice Flour | 32.0 | — | — | — | — | — |

TABLE 26B
Composition of Organic Soy Protein Nuggets or Crisps with Soless ®
G101/Soless ® H102 Ratios (60% Protein).

| | Moisture | Protein | Fat | Ash | Calcium | Sodium |
|---|---|---|---|---|---|---|
| | (%) | (%) | (%) | (%) | (%) | (%) |
| S12.1. Soless ® G101 | 3.27 | 60.4 | 9.45 | 5.09 | 1.23 | 0.399 |
| S12.2. Soless ® G101/Soless ® | 3.16 | 61.9 | 8.82 | 5.34 | 1.26 | 0.382 |
| H102 3:1 | | | | | | |
| S12.3. Soless ® G101/Soless ® | 6.3 | 60.7 | 8.69 | 5.28 | 1.30 | 0.404 |
| H102 1:1 | | | | | | |
| S12.4. Soless ® G101/Soless ® | 9.86 | 58.9 | 7.58 | 5.21 | 1.27 | 0.378 |
| H102 1:3 | | | | | | |
| S12.5. Soless ® H102 | 11.5 | 56.3 | 7.65 | 5.13 | 1.20 | 0.407 |

TABLE 26C
Physical Properties of Organic Soy Protein Nuggets or Crisps with Sloess G101/Soless H102 Ratios
(60% Protein).

| | Control | S12.1 | S12.2 | S12.3 | S12.4 | S12.5 |
|---|---|---|---|---|---|---|
| | S8000/S620 | Soless ® | SG101/SH102 | SG101/SH102 | SG101/SH102 | Soless ® |
| | 3:1 | G101 | 3:1 | 1:1 | 1:3 | H102 |
| Density Average (g/cc) | 0.2130 | 0.3142 | 0.2745 | 0.2754 | 0.3285 | 0.3221 |
| Density Average | 13.3 | 19.6 | 17.1 | 17.2 | 20.5 | 20.1 |
| (lb.cu.ft.) | | | | | | |
| Color: | | | | | | |
| L Value | 56.22 | 54.36 | 53.87 | 51.74 | 50.24 | 46.81 |
| A Value | 3.37 | 2.88 | 3.18 | 3.54 | 2.87 | 4.08 |
| B Value | 20.84 | 18.68 | 19.21 | 19.42 | 18.54 | 18.26 |
| Granulation (%): | | | | | | |
| US # 4 ON | 29.89 | 0.13 | 0.54 | 8.62 | 12.17 | 21.49 |
| US # 6 ON | 70.32 | 88.74 | 99.10 | 91.14 | 83.70 | 76.01 |
| US # 8 ON | 0.04 | 11.15 | 0.48 | 0.46 | 4.38 | 2.17 |
| PAN | 0.11 | 0.04 | 0.07 | 0.10 | 0.09 | 0.39 |
| Texture: | | | | | | |
| Texture Force | | | | | | |
| Compression: | | | | | | |
| F/T Average (kg/mm) | 5.80 | 10.51 | 8.35 | 3.77 | 4.07 | 1.94 |
| One-Step Bulk | | | | | | |
| Compression: | | | | | | |
| Force/Travel (kg/mm) | 5.93 | 11.59 | 8.92 | 5.21 | 4.87 | 2.74 |
| Three Compressions (kg): | | | | | | |
| First Compression | 44.70 | 56.1 | 56.1 | 35.6 | 40.8 | 18.4 |
| Second Compression | 36.10 | 55.9 | 56.1 | 27.9 | 30.9 | 13.4 |
| Third Compression | 35.00 | 56.1 | 54.1 | 25.5 | 29.3 | 15.7 |

### Example 13

### Textured Organic Soy Protein Products

Protein extrudates were prepared generally according to the process described in Example 1 and using the extrusion parameters in Example 6. The formulations, composition, and physical characteristics of the protein extrudates are described in the tables below.

TABLE 27A
Formulations For Textured Organic Soy Protein Products - Shreds.

| | S13.1A | S13.2A | S13.3A | S13.4A | S13.5A | S13.6A | S13.7A | S13.8A |
|---|---|---|---|---|---|---|---|---|
| | 50-60% | 50-60% | 60-70% | 70-80% | 70-80% | 70-80% | 80-90% | 80-90% |
| | Protein | Protein. | Protein | Protein | Protein | Protein | Protein | Protein. |
| Soless ® G101 | 45.0 | — | 65.0 | 69.5 | 32.0 | 100.0 | — | — |
| Safe Soy ® Flour | 54.5 | 69.5 | 34.5 | — | 32.5 | — | — | — |
| Soy Quick ® or Soy- | — | 30.0 | — | 30.0 | 35.0 | — | 99.1 | — |
| Nergy ® ISP 90 | | | | | | | | |
| Solae NAP ISP | — | — | — | — | — | — | — | 99.6 |
| Dicalcium Phosphate | 0.5 | 0.5 | 0.5 | 0.5 | 0.5 | — | 0.5 | — |
| Dihydrate | | | | | | | | |
| Soy Lecithin | — | — | — | — | — | — | 0.3 | 0.3 |
| L-Cysteine HCl | — | — | — | — | — | — | 0.1 | 0.1 |
| Monohydrate | | | | | | | | |

TABLE 27B
Formulations For Textured Organic Soy Protein Products - Wheat
Gluten/Gluten Free Chunks and Shreds.

| | S13.1B | S13.2B | S13.3B | S13.4B | S13.5B | S13.6B | S13.7B |
|---|---|---|---|---|---|---|---|
| | 70-80% | 70-80% | 70-80% | 70-80% | 70-80% | 70-80% | 70-80% |
| | Protein | Protein | Protein | Protein | Protein | Protein | Protein |
| Soless ® G101 | 79.9 | 87.9 | 27.0 | 33.0 | 25.0 | — | — |
| Vital Wheat Gluten | 12.0 | — | 12.0 | — | 12.0 | 12.0 | — |
| Soy Quick ® or Soy-Nergy ® | — | — | 48.4 | 54.4 | 45.9 | — | — |
| ISP 90 | | | | | | | |
| Solae NAP ISP | — | — | — | — | — | 75.6 | 87.6 |
| Tapioca Starch | 12.0 | 12.0 | 12.0 | 12.0 | 12.0 | 12.0 | 12.0 |
| Safe Soy Flour | — | — | — | — | 5.0 | — | — |
| Dicalcium Phosphate | — | — | 0.5 | 0.5 | 0.5 | — | — |
| Dihydrate | | | | | | | |
| Soy Lecithin | — | — | — | — | — | 0.3 | 0.3 |
| L-Cysteine HCl Monohydrate | 0.1 | 0.1 | 0.1 | 0.1 | 0.1 | 0.1 | 0.1 |

TABLE 27C
Formulations For Caramel Colored Textured Organic Soy Protein Products - Wheat
Gluten/Gulten Free Chunks and Shreds.

| | | | | | S13.5C | S13.6C | S13.7C | S13.8C |
|---|---|---|---|---|---|---|---|---|
| | S13.1C | S13.2C | S13.3C | S13.4C | 65-70% | 65-70% | 70-80% | 70-80% |
| | 50-60% | 60-70% | 70-80% | 80-90% | Pro. | Pro. | Pro. | Pro. |
| | Pro. | Pro. | Pro. | Pro. | Chunk/ | Chunk/ | Chunk/ | Chunk/ |
| | Shred | Shred | Shred | Shred | Shred | Shred | Shred | Shred |
| Soless ® G101 | 45.0 | 65.0 | 99.5 | — | 75.4 | 87.4 | — | — |
| Safe Soy ® Flour | 54.0 | 34.0 | — | — | — | — | — | — |
| Vital Wheat Gluten | — | — | — | — | 12.0 | — | 12.0 | — |
| Solae NAP ISP | — | — | — | 99.1 | — | — | 75.1 | 87.1 |
| Tapioca Starch | — | — | — | — | 12.0 | 12.0 | 12.0 | 12.0 |
| Dicalcium Phosphate | 0.5 | 0.5 | — | — | — | — | — | — |
| Dihydrate | | | | | | | | |
| Caramel Color | 0.5 | 0.5 | 0.5 | 0.5 | 0.5 | 0.5 | 0.5 | 0.5 |
| Soy Lecithin | — | — | — | 0.3 | — | — | 0.3 | 0.3 |
| L-Cysteine HCl | — | — | — | 0.1 | 0.1 | 0.1 | 0.1 | 0.1 |
| Monohydrate | | | | | | | | |

TABLE 28A
Composition of Textured Organic Soy Protein Products - Shreds.

| | Moisture | Protein | Fat | Ash | Calcium | Sodium |
|---|---|---|---|---|---|---|
| | (%) | (%) | (%) | (%) | (%) | (%) |
| S13.1A. Soless ® G101/Soy Flour 50-60% | 4.97 | 62.3 | 8.42 | 5.79 | 0.688 | 0.168 |
| Pro. | | | | | | |
| S13.2A. Soy Flour/Soy Nergy ® ISP 50-60% | 4.34 | 60.1 | 6.52 | 5.28 | 0.345 | 0.518 |
| Pro. | | | | | | |
| S13.3A. Soless ® G101/Soy Flour 60-70% | 5.94 | 66.9 | 8.50 | 5.56 | 0.632 | 0.257 |
| Pro. | | | | | | |
| S13.4A. Soless ® G101/Soy Nergy ® 70-80% | 4.08 | 76.7 | 9.50 | 5.50 | 0.786 | 0.719 |
| Pro. | | | | | | |
| S13.5A. Soless ® G101/S Flour/Soy | 5.61 | 71.6 | 8.37 | 5.10 | 0.687 | 0.783 |
| Nergy ® 70-80% Pro. | | | | | | |
| S13.6A. Soless ® G101 70-80% Protein | 5.88 | 75.5 | 10.3 | 5.72 | 0.876 | 0.345 |
| S13.7A. Soy Nergy ® ISP 80-90% Protein | 4.97 | 83.7 | 5.91 | 5.59 | 0.799 | 0.721 |
| S13.8A. Solae NAP ISP 80-90% Protein | 5.35 | 85.1 | 3.73 | 5.92 | 1.38 | 0.349 |

TABLE 28B
Composition of Textured Organic Soy Protein Products - Gluten/Gluten Free
Chunks and Shreds.

| | Moisture | Protein | Fat | Ash | Calcium | Sodium |
|---|---|---|---|---|---|---|
| | (%) | (%) | (%) | (%) | (%) | (%) |
| S13.1B. Soless ® G101/Gluten 70-80% | 4.95 | 70.0 | 8.19 | 4.81 | 1.20 | 0.291 |
| Protein | | | | | | |
| S13.2B. Soless ® G101 70-80% Protein | 4.77 | 75.8 | 9.73 | 5.26 | 1.36 | 0.291 |
| S13.3B. Soless ® G101/S Nergy ®/Glu 70-80% | 3.84 | 73.9 | 6.76 | 4.29 | 0.846 | 0.517 |
| Pro. | | | | | | |
| S13.4B. Soless ® G101/Soy Nergy ® 70-80% | 4.31 | 74.0 | 6.31 | 4.23 | 0.858 | 0.543 |
| Pro. | | | | | | |
| S13.5B. Soless ® G101/S Nergy/S | 7.43 | 69.2 | 5.92 | 3.96 | 0.746 | 0.549 |
| Flour/Glu 70-80% Pro. | | | | | | |
| S13.6B. Solae NAP ISP/Gluten 70-80% | 3.96 | 74.7 | 4.20 | 4.62 | 1.10 | 0.301 |
| Protein | | | | | | |
| S13.7B. Solae NAP ISP 70-80% Protein | 3.87 | 76.0 | 3.42 | 5.29 | 1.31 | 0.268 |

TABLE 28C
Composition of Caramel Colored Textured Organic Soy Protein Products -
Gluten/Gluten Free Chunks and Shreds.

| | Moisture | Protein | Fat | Ash | Calcium | Sodium |
|---|---|---|---|---|---|---|
| | (%) | (%) | (%) | (%) | (%) | (%) |
| S13.1C. Soless ® G101/Soy Flour 50-60% | 6.65 | 58.3 | 10.4 | 5.48 | 0.965 | 0.153 |
| Protein | | | | | | |
| S13.2C. Soless ® G101/Soy Flour 60-70% | 5.80 | 66.6 | 10.0 | 5.48 | 1.14 | 0.245 |
| Protein | | | | | | |
| S13.3C. Soless ® G101 70-80% Protein. | 4.10 | 74.9 | 11.0 | 5.73 | 1.43 | 0.320 |
| S13.4C. Solae NAP ISP 80-90% Protein | 5.70 | 80.9 | 2.51 | 5.25 | 1.48 | 0.271 |
| S13.5C. Soless ® G101/Starch/Gluten | 3.59 | 67.8 | 7.7 | 4.48 | 1.21 | 0.290 |
| 65-70% Protein. | | | | | | |
| S13.6C. Soless ® G101/Starch 65-70% | 3.84 | 68.4 | 7.29 | 3.28 | 1.19 | 0.255 |
| Protein | | | | | | |
| S13.7C. Solae NAP ISP/Starch/Gluten | 4.18 | 75.4 | 3.39 | 4.72 | 1.18 | 0.233 |
| 70-80% Protein | | | | | | |
| S13.8C. Solae NAP ISP/Starch 70-80% | 4.47 | 76.8 | 2.60 | 5.25 | 1.31 | 0.255 |
| Protein | | | | | | |

TABLE 29A
Physical Properties of Textured Organic Soy Protein
Products - Shreds.

| | | | | | | | S13.7A | S13.8A |
|---|---|---|---|---|---|---|---|---|
| | S13.1A | S13.2A | S13.3A | S13.4A | S13.5A | S13.6A | Soy | Solae |
| | SG101/ | SFlour/ | SG101/ | SFlour/ | SG101/ | Soless | Nergy | NAP |
| | SFlour | SNergy | SFlour | SNergy | SF/SN | G101 | ISP | ISP |
| | 50-60% | 50-60% | 60-70% | 70-80% | 70-80% | 70-80% | 80-90% | 80-90% |
| | Pro. | Pro. | Pro. | Pro. | Pro. | Pro. | Pro. | Pro. |
| Density Average | 0.280 | 0.402 | 0.196 | 0.321 | 0.269 | 0.340 | 0.294 | 0.253 |
| (g/cc) | | | | | | | | |
| Density Average | 17.47 | 25.10 | 12.24 | 20.03 | 16.78 | 21.24 | 18.36 | 15.75 |
| (lb.cu.ft.) | | | | | | | | |
| Color Dry Samples: | | | | | | | | |
| L Value | 59.93 | 59.92 | 61.44 | 52.23 | 57.84 | 56.63 | 55.81 | 57.81 |
| A Value | 2.54 | 2.54 | 3.12 | 4.17 | 3.6 | 3.58 | 2.32 | 1.70 |
| B Value | 22.10 | 22.09 | 19.99 | 18.17 | 20.38 | 17.87 | 17.85 | 17.12 |
| Color Wet Samples: | | | | | | | | |
| L Value | 57.43 | 55.03 | 58.19 | 50.47 | 53.54 | 49.62 | 49.38 | 45.68 |
| A Value | 3.59 | 3.80 | 2.86 | 3.81 | 3.68 | 3.52 | 2.65 | 2.62 |
| B Value | 18.37 | 19.3 | 17.75 | 17.00 | 18.52 | 16 | 16.29 | 14.45 |
| Granulation (%): | | | | | | | | |
| US # ½ ON | 0.00 | 0.00 | 0.00 | 0.00 | 0.00 | 0.24 | 0.00 | 0.00 |
| US # ¼ ON | 46.42 | 38.08 | 59.85 | 59.98 | 53.04 | 39.97 | 31.67 | 46.61 |
| US # 7 ON | 40.76 | 48.89 | 32.45 | 31.98 | 32.73 | 40.54 | 37.75 | 40.81 |
| PAN | 12.88 | 12.97 | 7.87 | 8.12 | 14.29 | 19.51 | 31.88 | 12.64 |
| Texture (grams): | | | | | | | | |
| Force | 5456 | 5772 | 3748 | 7938 | 4793 | 7808 | 6375 | 4409 |
| Hydration (1 TVP: 4 | 2.08 | 1.36 | 2.87 | 1.93 | 2.50 | 1.44 | 2.02 | 2.19 |
| H2O) | | | | | | | | |

TABLE 29B
Physical Properties of Textured Organic Soy Protein Products - Wheat Gluten/Gluten Free Shreds.

| | S13.1B | S13.2B | S13.3B | S13.4B | S13.5B | S13.6B | S13.7B |
|---|---|---|---|---|---|---|---|
| | SG101/ | Soless | SG101/ | SG101/ | SG/SF/ | S NAP/ | S NAP |
| | Gluten | G101 | SN/Glu | SN | SN/Glu | Gluten | ISP |
| | 70-80% | 70-80% | 70-80% | 70-80% | 70-80% | 70-80% | 70-80% |
| | Pro. | Pro. | Pro. | Pro. | Pro. | Pro. | Pro. |
| Density Average (g/cc) | 0.161 | 0.191 | 0.153 | 0.179 | 0.146 | 0.100 | 0.111 |
| Density Average | 10.03 | 11.91 | 9.55 | 11.18 | 9.11 | 3.32 | 6.95 |
| (lb.cu.ft.) | | | | | | | |
| Color Dry Samples: | | | | | | | |
| L Value | 58.57 | 54.1 | 61.54 | 61.8 | 57.56 | 64.47 | 61.67 |
| A Value | 2.23 | 2.77 | 1.3 | 1.45 | 2.12 | 0.49 | 0.94 |
| B Value | 17.78 | 16.83 | 18.06 | 18.65 | 18.69 | 16.88 | 17.11 |
| Color Wet Samples: | | | | | | | |
| L Value | 57.87 | 52.59 | 57.74 | 58.78 | 59.03 | 59.07 | 55.53 |
| A Value | 1.68 | 2.04 | 1.58 | 1.43 | 1.71 | 1.55 | 2.00 |
| B Value | 18.76 | 15.43 | 16.51 | 16.42 | 17.25 | 15.48 | 15.25 |
| Granulation (%): | | | | | | | |
| US # ½ ON | 0.26 | 0.2 | 0.19 | 0.19 | 0.05 | 0.47 | 0.02 |
| US # ¼ ON | 52.66 | 72.61 | 19.05 | 21.64 | 45.06 | 25.7 | 22.18 |
| US # 7 ON | 38.54 | 24.87 | 20.8 | 20.44 | 41.49 | 17.96 | 20.75 |
| PAN | 8.63 | 2.44 | 10.24 | 7.95 | 14.51 | 5.79 | 6.97 |
| Texture (grams): | | | | | | | |
| Force | 4422 | 5212 | 3160 | 3345 | 4503 | 3014 | 3173 |
| Hydration (1 TVP: 4 | 2.74 | 2.28 | 3.22 | 3.14 | 2.65 | 1.99 | 1.85 |
| H2O) | | | | | | | |

TABLE 29C
Physical Properties of Textured Organic Soy Protein Products - Wheat
Gluten/Gluten Free Chunks.

| | | Bulk | Piece | | |
|---|---|---|---|---|---|
| | Shear | Density | Density | Length | Width |
| | (gram) | (g/cc) | (g/cc) | (mm) | (mm) |
| S13.1B. Soless ® G101/Gluten 70-80% | 2834.57 | 0.217 | 0.395 | 42.63 | 25.83 |
| Protein | | | | | |
| S13.2B. Soless ® G101 70-80% Protein | 5348.11 | 0.183 | 0.459 | 42.86 | 22.39 |
| S13.3B. Soless ® G101/S Nergy/Glu 70-80% | 2308.46 | 0.232 | 0.453 | 42.83 | 24.08 |
| Pro. | | | | | |
| S13.4B. Soless ® G101/Soy Nergy ® 70-80% | 2248.68 | 0.179 | 0.343 | 47.21 | 24.88 |
| Pro. | | | | | |
| S13.5B. Soless ® G101/S Nergy/S | 1754.20 | 0.223 | 0.365 | 42.03 | 25.36 |
| Flour/Glu 70-80% Pro. | | | | | |
| S13.6B. Solae NAP ISP/Gluten 70-80% | 3434.91 | 0.120 | 0.487 | 61.71 | 36.15 |
| Protein | | | | | |
| S13.7B. Solae NAP ISP 70-80% | 3434.91 | 0.170 | 0.291 | 43.58 | 32.19 |
| Protein | | | | | |

TABLE 29D
Physical Properties of Caramel Colored Textured Organic Soy Protein Products - Wheat
Gluten/Gluten Free Shreds.

| | S13.1C | S13.2C | | S13.4C | S13.5C | S13.6C | S13.7C | S13.8C |
|---|---|---|---|---|---|---|---|---|
| | SG101/S | SG101/S | S13.3C | Solae | SG101/ | SG101/ | S NAP/ | S |
| | Flour | Flour | SG101 | NAP ISP | St./Glu | St. | St./Glu | NAP/St. |
| | 50-60% | 60-70% | 70-80% | 80-90% | 65-70% | 65-70% | 70-80% | 70-80% |
| | Pro. | Pro. | Pro. | Pro. | Pro. | Pro. | Pro. | Pro. |
| Density Average | 0.393 | 0.303 | 0.211 | 0.128 | 0.098 | 0.118 | 0.080 | 0.079 |
| (g/cc) | | | | | | | | |
| Density Average | 24.54 | 18.92 | 13.16 | 8.01 | 6.14 | 7.37 | 5.02 | 4.91 |
| (lb.cu.ft.) | | | | | | | | |
| Color Dry Samples: | | | | | | | | |
| L Value | 40.62 | 40.37 | 41.42 | 41.85 | 45.21 | 44.48 | 46.22 | 46.51 |
| A Value | 4.58 | 4.64 | 4.52 | 3.89 | 3.91 | 4.06 | 3.97 | 3.92 |
| B Value | 14.52 | 14.27 | 13.53 | 12.84 | 14.86 | 14.43 | 14.60 | 14.61 |
| Color Wet Samples: | | | | | | | | |
| L Value | 41.80 | 42.12 | 40.61 | 39.54 | 45.38 | 45.36 | 41.90 | 41.29 |
| A Value | 4.90 | 4.64 | 4.70 | 4.65 | 3.72 | 3.94 | 4.49 | 4.69 |
| B Value | 15.16 | 13.70 | 14.39 | 13.38 | 14.60 | 14.88 | 14.02 | 14.07 |
| Granulation (%): | | | | | | | | |
| US # ½ ON | 0.0 | 0.0 | 0.0 | 0.0 | 0.0 | 0.0 | 0.0 | 0.0 |
| US # ¼ ON | 25.99 | 52.11 | 34.15 | 24.70 | 29.50 | 30.15 | 28.61 | 32.34 |
| US # 7 ON | 52.57 | 38.21 | 41.80 | 45.17 | 43.81 | 45.17 | 42.15 | 41.77 |
| PAN | 21.44 | 8.64 | 24.05 | 30.13 | 26.69 | 24.69 | 29.24 | 25.76 |
| Texture (grams): | | | | | | | | |
| Force | 4399.29 | 7706.59 | 5384.19 | 2465.70 | 2214.19 | 1814.55 | 1776.93 | 2088.29 |
| Hydration (1 TVP: 4 | 1.62 | 1.71 | 2.52 | 3.09 | 3.44 | 3.75 | 3.99 | 3.70 |
| H2O) | | | | | | | | |

TABLE 29E
Physical Properties of Caramel Colored Textured Organic Soy Protein Products -
Wheat Gluten/Gluten Free Chunks.

| | | Bulk | Piece | | |
|---|---|---|---|---|---|
| | Shear | Density | Density | Length | Width |
| | (gram) | (g/cc) | (g/cc) | (mm) | (mm) |
| S13.1C. Soless ® G101/Soy Flour 50-60% | — | — | — | — | — |
| Protein | | | | | |
| S13.2C. Soless ® G101/Soy Flour 60-70% | — | — | — | — | — |
| Protein | | | | | |
| S13.3C. Soless ® G101 70-77% Protein. | — | — | — | — | — |
| S13.4C. Solae NAP ISP 80-90% | — | — | — | — | — |
| Protein | | | | | |
| S13.5C. Soless ® G101/Starch/Gluten | 2052.90 | 0.201 | 0.367 | 41.95 | 34.82 |
| 65-70% Protein. | | | | | |
| S13.6C. Soless ® G101/Starch 65-70% | 2475.24 | 0.187 | 0.368 | 48.85 | 31.38 |
| Protein | | | | | |
| S13.7C. Solae NAP ISP/Starch/Gluten | 2105.71 | 0.127 | 0.271 | 67.94 | 36.21 |
| 70-80% Protein | | | | | |
| S13.8C. Solae NAP ISP/Starch 70-80% | 2263.37 | 0.128 | 0.252 | 52.07 | 37.62 |
| Protein | | | | | |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above particles and processes without departing from the scope of the invention, it is intended that all matter contained in the above description and shown in the accompanying drawings shall be interpreted as illustrative and not in a limiting sense.

What is claimed is:

1. A protein extrudate comprising at least 15 wt. % vegetable protein on a moisture-free basis, from 5.5 wt. % to 13 wt. % fat on a moisture-free basis, the extrudate having a density from 0.0.02 to 0.5 g/cm³.

2. The protein extrudate of claim 1 wherein the vegetable protein comprises soy protein.

3. The protein extrudate of claim 2 wherein the extrudate comprises at least 50 wt. % soy protein on a moisture-free basis.

4. The protein extrudate of claim 2 wherein the extrudate comprises at least 60 wt. % soy protein on a moisture-free basis.

5. The protein extrudate of claim 2 wherein the extrudate comprises at least 70 wt. % soy protein on a moisture-free basis.

6. The protein extrudate of claim 2 wherein the extrudate comprises at least 80 wt. % soy protein on a moisture-free basis.

7. The protein extrudate of claim 2 wherein the extrudate comprises at least 90 wt. % soy protein on a moisture-free basis.

8. The protein extrudate of claim 1 wherein the extrudate comprises from about 7 to 13 wt. % fat on a moisture-free basis.

9. The protein extrudate of claim 2 wherein the extrudate comprises from about 7 to 13 wt. % fat on a moisture-free basis.

10. The protein extrudate of claim 2 wherein the extrudate comprises from about 8 to 13 wt. % fat on a moisture-free basis.

11. The protein extrudate of claim 2 wherein the extrudate comprises from about 9 to 13 wt. % fat on a moisture-free basis.

12. The protein extrudate of claim 2 wherein the extrudate comprises from about 10 to 13 wt. % fat on a moisture-free basis.

13. The protein extrudate of claim 2 having a density from 0.15 to 0.25 g/cm³.

14. The protein extrudate of claim 2 having a density from 0.02 to 0.10 g/cm³.

15. The protein extrudate of claim 2 having a density from 0.05 to 0.15 g/cm³.

16. The protein extrudate of claim 2 wherein the soy protein is a certified organic soy protein.

17. A food product comprising the protein extrudate of claim 1.

18. The food product of claim 17 wherein the vegetable protein comprises soy protein.

19. The food product of claim 18 wherein the food product is a snack food.

20. The food product of claim 18 wherein the food product is a breakfast food.
